(19) United States
(12) Patent Application Publication
(10) Pub. No.: US 2018/0297880 A1
(43) Pub. Date: Oct. 18, 2018

(54) Liquid treatment station indluding plural mobile units and methods for operation theror

(71) Applicant: Rockwater Resource, LLC, Denver, CO (US)

(72) Inventors: Reginald A. Wiemers, Littleton, CO (US); Bardia B. Khalili, Denver, CO (US); Werner Roeder, Stuttgart (DE)

(73) Assignee: Rockwater Resource, LLC, Denver, CO (US)

(21) Appl. No.: 15/998,029

(22) Filed: Jun. 14, 2018

Related U.S. Application Data
(63) Continuation of application No. 15/330,584, filed on Oct. 15, 2016, now abandoned.
Application No. 15/330,584 is a continuation of application No. 13/987,088, filed on Jul. 1, 2013, now abandoned.

(51) Int. Cl. C02F 9/00; B01D 17/04; C02F 1/56; C02F 1/00; B01D 17/02; E21B 43/34; C02F 101/20; C02F 1/68; C02F 1/66; C02F 1/52; C02F 101/32; C02F 103/10; E21B 43/26

(52) U.S. Cl. CPC C02F 9/00; E21B 43/26; C02F 1/56; C02F 1/008; B01D 17/0208; E21B 43/34; C02F 2101/20; C02F 1/685; C02F 1/66; C02F 1/5236; C02F 1/5209; C02F 1/001; C02F 2101/32; C02F 2103/10; C02F 2201/008; C02F 2209/11; C02F 2209/42; B01D 17/047

(57) ABSTRACT

A mobile liquid treatment station and operation methods are disclosed, the station having a mobile treatment unit and separate mobile treatment management unit. A plurality of serial containment compartments at the treatment unit for performance of chemical dosing and solids separation are provided and are monitored with sensors. The management unit includes a plurality of chemical dosing platforms, arid a power and processing assembly. A bus links the units for data and control signal transfer and chemical feed lines are connected between the units for transfer of dosing chemicals.

### RELATED APPLICATION

This Application is a Continuation of pending U.S. patent application Ser. No. 15/330,584 by the Inventors herein and entitled LIQUID TREATMENT STATION INCLUDING PLURAL MOBILE UNITS AND METHODS FOR OPERATION THEREOF, which is a Continuation of U.S. patent application Ser. No. 13/987,088 having the same title by the same inventors filed Jul. 1, 2013 and now abandoned.

### FIELD OF THE INVENTION

This invention is related to cleaning of liquids, especially water, and more particularly relates to industrial process liquid cleaning at remote locations such as oil or gas well drilling sites and the like.

### BACKGROUND OF THE INVENTION

Mobile water treatment units have been heretofore suggested and/or utilized for various purposes including facilities modeling (see U.S. Patent Publication No. 2009/0032346), emergency or remote water supply (see U.S. Pat. Nos. 6,464,884, 5,632,892, 6,120,688, and 6,228,255), mining and industrial uses (see U.S. Pat. Nos. 4,383,920, 5,558,775, 5,547,584 and 6,607,668, and U.S. Patent Publication No. 2012/0312755), and addressing polluted water sources and waterways (see U.S. Patent Publication No. 2002/0033363 and U.S. Pat. Nos. 5,741,416 and 5,972,216). These units have often required extensive power supply installations and/or site preparations (leveling, leak sealing and the like). Such devices have not proven entirely effective in the field of oil and gas drilling and production.

In induced hydraulic fracturing or hydro-fracturing a slurry of water mixed with sand and chemicals (“fracking fluids”) is injected at high pressure into oil and gas well bores to cause fracturing of surrounding rock structures. Hydro-fracturing techniques have improved fluids migration and well production. However, fracking utilizes large quantities of water at the well site, often taken from a regional water supply having numerous alternative uses including industrial, agricultural and municipal uses. Fresh water used for such purposes must often be trucked to the well site for makeup of fracking fluids. Moreover, a large percentage of the fracking fluid returns to the surface of the well after mixing with fluid and other substances in the fractured rock formation (called “flowback”). Thus, a large quantity of unclean water (fracking flowback liquid) including the fracking fluid itself and liquids and solids that are native to the oil and gas producing formation (such a petroleum products and heavy metals) must be treated or safely disposed of. Trucking flowback fluids offsite for disposal or treatment is expensive.

Treatment of flowback liquid at the well site for reuse would result in large reductions of freshwater supplied to and used at the site while reducing waste water and the related costs thereof. Reduction in use of fresh water resources and related transportation costs and reduction of waste water volumes and related transportation and off-site treatment or disposal costs would thus be highly desirable in oil and gas extraction operations and would also benefit the communities where drilling occurs.

### SUMMARY OF THE INVENTION

This invention provides a liquid treatment station and plural mobile treatment units and methods for control and operation thereof. This invention is particularly well adapted for improved industrial process water treatment, for example flowback water treatment at oil and gas hydraulic fracturing sites. The station has separate mobile treatment and mobile treatment management units, the mobile liquid treatment unit being greatly improved over similar heretofore utilized treatment technologies. The liquid treatment management unit controls operation of the liquid treatment unit and provides control of chemical dosing. The station and units of this invention require minimal utility support/supply and site preparation, provide effective and safe treatment of water, and have enhanced throughput at reduced cost at industrial treatment sites such as oil and gas drilling and production sites. The units thereby reduce water hauling and related costs to well sites and waste water hauling away from well sites, while conserving water resources.

The mobile primary liquid treatment unit of this invention includes a mobile platform having a foul liquid intake end and a purified liquid output end. A plurality of liquid containment compartments each having a volume with an upper portion and a lower portion are defined and serially arranged at the mobile platform. The compartments in turn define plural serial cascade stages, each of the stages cascading from one to the next between the intake end and the output end. A majority of the compartments have structure for liquid inflow at the lower portion of the volume thereof from an adjacent compartment and structure for liquid outflow at the upper portion of the volume thereof to another adjacent compartment.

The liquid treatment station of this invention includes both the mobile primary liquid treatment unit and an independently mobile treatment management unit. Selected liquid treatment functions are performed at the containment compartments of the primary treatment unit including chemical dosing and mixing and solids separation. A plurality of sensors with sensor outputs, a plurality of chemical dosing pumps, mixers and valves having connections for operational control and feedback, and a power and data transfer terminal are located at the primary treatment unit. The management unit preferably includes a mobile platform having a treatment controller center, a chemical dosing control center and at least a first auxiliary functions center thereat. A plurality of chemical dosing platforms and a central power and processing assembly including an externally located power and data input and output terminal are located at the management unit, the dosing platforms including chemical storage connectable with dosing pump assemblies operatively associated with the power and processing assembly and have dosing outputs connected with a dosing manifold.

A bus is connectable between the power and data input and output terminal at the management unit and the power and data transfer terminal at the primary treatment unit. Chemical feed line assemblies are selectively connectable between the dosing manifold of the management unit and the dosing inputs at the primary treatment unit. In this manner chemical dosing control, pump, mixer and valve operational control, and feedback and data acquisition at both the units are controlled at the power and processing assembly of the management unit.

A pressure sensor is connected between the power and processing assembly at the management unit and an on-site source of foul fluid received at a feed pump located at the intake end of the primary treatment unit. Infeed and throughflow are monitored and controlled by reference to available volume of foul fluid at the source.

The treatment unit includes at least seven water containment and treating compartments (preferably eight, including a buffer compartment). The structure for liquid inflow include a plurality of intervening diving structures one of adjacent to or located between at least some of the compartments for receiving and directing liquid to an adjacent compartment at the lower portion thereof. Each of the compartments has flow accommodating components thereat. At least some of the compartments include liquid flow leveling features for independent adjustment of the flow accommodating components in both longitudinal and transverse directions. The features thereby selectively compensate for unlevel location of the mobile platform at a treatment site and thus unit sloping.

The methods of this invention for process control of a mobile liquid treatment unit include the steps of sensing attributes of liquid to be treated at the treatment unit and providing first electronic outputs indicative thereof. Attributes of operational functioning of selected treatment unit components are sensed and second electronic outputs indicative thereof are provided. The electronic outputs are received remotely from the treatment unit at an automated treatment management unit and process control signals are generated responsive thereto. Chemical dosing at the management unit is prepared responsive to the control signals. The control signals are received at the treatment unit for selectively adapting the attributes of operational functioning responsive thereto, and chemical dosing is received at the treatment unit from the prepared chemical dosing at the treatment management unit. Volume of liquid to be treated at a source tank is sensed and third electronic output indicative thereof is provided, this output also received remotely from the source tank at the management unit. Flow rate control signals are generated responsive thereto, the control signals received at the treatment unit for adapting the attributes of operational functioning related to liquid infeed and throughflow responsive thereto.

The methods for operation of a mobile liquid treatment station include the steps of intake of liquid to be treated at a mobile primary liquid treatment unit and cascading the liquid serially through a plurality of liquid treatment compartments. Selected liquid treatment functions are performed at the compartments responsive to process control programming at an independently mobile treatment management unit, the treatment functions including chemical dosing and mixing and solids separation, Attributes of the liquid at the treatment unit and of operational functioning of selected treatment unit components are sensed and electronic outputs indicative thereof are provided. The outputs are received at the treatment management unit whereat chemical dosing is prepared responsive thereto. The prepared chemical dosing is fed from the treatment management unit to selected ones of the compartments of the treatment unit. After treatment completion, the treated liquid is output from the treatment unit.

It is therefore an object of this invention to provide a liquid treatment station and plural mobile treatment units and methods for control and operation thereof.

It is another object of this invention to provide a liquid treatment station having separate mobile treatment and mobile treatment management units.

It is yet another object of this invention to provide improved mobile liquid treatment units and methods.

It is another object of this invention to provide a mobile liquid treatment management unit and methods for control of a liquid treatment unit.

It is still another object of this invention to provide methods for separate control of chemical dosing and liquid treatment at a liquid treatment station.

It is another object of this invention to provide improved flowback water treatment and methods at oil and gas fracking sites.

It is still another object of this invention to provide a mobile liquid treatment station and units which require minimal utility support/supply and site preparation.

It is yet another object of this invention to provide a mobile liquid treatment station and methods that provide effective and safe treatment of water and have enhanced throughput at reduced cost at industrial treatment sites such oil and gas drilling and production sites.

It is still another object of this invention to provide a mobile liquid treatment station having mobile units and methods that reduce water hauling to and from treatment sites, use of precious water supply and water treatment resources, and related costs.

It is yet another object of this invention to provide a mobile liquid treatment unit that includes a mobile platform having a foul liquid intake end and a purified liquid output end, and a plurality of liquid containment compartments each having a volume with an upper portion and a lower portion, the compartments defined and serially arranged at the mobile platform for defining plural serial cascade stages from the intake end to the output end, each of the stages cascading from one to the next between the intake end and the output end, and a majority of the compartments each including structure for liquid inflow at the lower portion of the volume thereof from an adjacent compartment and structure for liquid outflow at the upper portion of the volume thereof to another adjacent compartment.

It is yet another object of this invention to provide a mobile liquid treatment station that includes a mobile primary liquid treatment unit having a foul liquid intake end and a purified liquid output end with a plurality of liquid containment compartments defined and serially arranged therebetween for performance of selected liquid treatment functions thereat including chemical dosing and mixing and solids separation, the primary treatment unit having a plurality of sensors thereat with sensor outputs, a plurality of chemical dosing inputs at different ones of the compartments, a plurality of pumps, mixers and valves having connections for operational control and feedback, and a power and data transfer terminal connected with the connections of the pumps, mixers and valves and the sensor outputs from the sensors, an independently mobile treatment management unit having a plurality of chemical dosing platforms, an externally located dosing manifold and a central power and processing assembly therein, the power and processing assembly including an externally located power and data input and output terminal, and the chemical dosing platforms including chemical storage connectable with dosing pump assemblies operatively associated with the power and processing assembly and having dosing outputs connected with the manifold, a bus connectable between the power and data input and output terminal of the power and processing assembly of the management unit and the power and data transfer terminal of the primary treatment unit, and chemical feed line assemblies selectively connectable between the dosing manifold of the management unit and the dosing inputs at the compartments of the primary treatment unit, wherein chemical dosing control, pump, mixer and valve operational control, and feedback and data acquisition at both the units are controlled at the power and processing assembly of the management unit.

It is another object of this invention to provide a mobile liquid treatment station having a primary treatment unit and a separate treatment management unit than includes a pressure sensor connected between the treatment management unit and an on-site source of foul fluid received at a feed pump located at the intake end of the primary treatment unit for infeed and throughflow control and monitoring based on available volume of foul fluid at the source.

It is still another object of this invention to provide a treatment unit for receiving and processing industrial process water that includes a mobile platform having a foul water intake end and a purified water output end, at least seven water containment and treating compartments at the mobile platform serially arranged between the ends and each having an upper portion and a lower portion, and a plurality of intervening diving structures one of adjacent to or located between at least some of the compartments for receiving and directing the process water to an adjacent compartment at the lower portion thereof.

It is still another object of this invention to provide a mobile liquid treatment unit locatable at a selected site having a mobile platform with a foul liquid intake end and a purified liquid output end, and a plurality of liquid containment and treating compartments defined at the mobile platform and serially arranged between the ends to provide cascading flow between at least some of the compartments and each having flow accommodating components thereat, at least some of the compartments including liquid flow leveling features for independent adjustment of the flow accommodating components located therein in both longitudinal and transverse directions to selectively compensate for unlevel location of the mobile platform at the site and thus unit sloping.

It is yet another object of this invention to provide a mobile liquid treatment management unit which includes a mobile platform, a treatment controller center located at the platform and including a remotely accessible control output and feedback input, a chemical dosing control center located at the platform and operatively associated with the controller center and including remotely accessible chemical dosing outputs, and at least a first auxiliary functions center located at the platform.

It is still another object of this invention to provide a mobile station for liquid treatment at a site that includes a primary liquid treatment unit maintained on a first trailer and having a foul liquid intake end and a purified liquid output end with a plurality of liquid treatment compartments and a plurality of intermediate structure defined and serially arranged therebetween, different ones of the compartments accommodating different liquid treatment including chemically enhanced oil/water separation, coagulation, pH-buffering, flocculation, and solids separation, the primary treatment unit having a plurality of chemical dosing inputs at a lower portion of different ones of the compartments and a plurality of mixer impellers at a lower portion of different ones of the compartments, the intermediate structure residing between the compartments and configured to provide primary liquid inflow to an adjacent downstream one of the compartments at the lower portion thereof and below any the chemical dosing input or the mixer impeller thereat, and the intermediate structure receiving primary liquid outflow from an adjacent upstream one of the compartments through a water level adjustable weir structure at an upper portion of the upstream one of the compartments, the weir structure adjustable to define maximum compartment treatment volume, the compartment volumes, the primary liquid inflow and outflow locations, relative the weir structure heights and the mixer impellers when provided promoting fluid lifting in the compartments during treatment and mixing and pumpless flow of fluid through the primary liquid treatment unit, a mobile treatment management unit maintained on a second trailer having a plurality of chemical dosing platforms and a central power and processing assembly therein, the chemical dosing platforms including chemical storage connectable with dosing pump assemblies operatively associated with the power and processing assembly and having dosing outputs, and means connectable between the units for power, data and chemical feed therebetween.

It is still another object of this invention to provide a mobile station for liquid treatment at a site comprising:

a primary liquid treatment unit maintained on a first trailer, a mobile treatment management unit maintained on a second trailer and including a treatment controller center located at the platform having a control output and feedback input associated therewith adapted at plural connection nodes, a chemical dosing control center located at the platform and operatively associated with the controller center and including chemical dosing outputs associated therewith to transfer dosing fluids from the management unit, and at least a first auxiliary functions center located at the platform, none of the centers having an inlet or outlet for direct receipt and distribution of the liquid to be treated on the site, and means connectable between the units for power, data and chemical feed therebetween.

It is yet another object of this invention to provide a method for process control of a mobile liquid treatment unit including the steps of sensing attributes of liquid to be treated at the treatment unit and providing first electronic outputs indicative thereof, sensing attributes of operational functioning of selected treatment unit components and providing second electronic outputs indicative thereof, receiving the electronic outputs remotely from the treatment unit at an automated treatment management unit and generating process control signals responsive thereto, preparing chemical dosing at the automated treatment management unit responsive to the control signals, receiving the control signals at the treatment unit for selectively adapting the attributes of operational functioning responsive thereto, and receiving chemical dosing at the treatment unit from the prepared chemical dosing at the treatment management unit.

It is another object of this invention to provide a method for process control of a mobile liquid treatment unit including the steps of sensing volume of liquid to be treated at a source tank and providing electronic output indicative thereof, receiving the electronic output remotely from the source tank at an automated treatment management unit and generating flow rate control signals responsive thereto, and receiving the flow rate control signals at a treatment unit for adapting attributes of operational functioning related to liquid infeed and throughflow responsive thereto.

It is yet another object of this invention to provide a method for operation of a mobile liquid treatment station locatable at a treatment site that includes locating separate trailer mounted liquid treatment and treatment management units adjacent to each other at the treatment site, intake at the liquid treatment unit of foul liquid for treatment, serially treating fluid in the liquid treatment unit in separate compartments thereof each separated by intermediate flow structure, treatment functions including chemically enhanced oil/water separation, coagulation, pH-buffering, flocculation, and solids separation, applying chemical dosing at a lower portion of different ones of the compartments, assisting lifting mixing by mixing impellers located at a lower portion of different ones of the compartments, providing primary liquid inflow from the intermediate flow structure between compartments to an adjacent downstream one of the compartments at the lower portion thereof and below any of the chemical dosing application or the lifting mixing impeller thereat, receiving primary liquid outflow to the intermediate flow structure between compartments from an adjacent upstream one of the compartments through outflow structure at an upper portion of the upstream one of the compartments, adjusting water level at the outflow structure to define maximum compartment treatment volume, whereby compartment volumes, primary liquid inflow and outflow locations, relative outflow structure heights and lifting mixing impellers promote fluid lifting in the compartments during treatment and mixing and pumpless flow of fluid through the liquid treatment unit, centrally powering both units, processing data and managing fluid flow from the treatment management unit, controlling chemical dosing and makeup from chemical storage and dosing assemblies at the treatment management unit, accommodating power, data flow and chemical feed between the units at the site, and output of purified fluid after treatment from the treatment unit.

With these and other objects in view, which will become apparent to one skilled in the art as the description proceeds, this invention resides in the novel construction, combination, and arrangement of parts and methods substantially as hereinafter described, and more particularly defined by the appended claims, it being understood that changes in the precise embodiment of the herein disclosed invention are meant to be included as come within the scope of the claims.

### BRIEF DESCRIPTION OF THE DRAWINGS

The accompanying drawings illustrate a complete embodiment of the invention according to a mode devised for the practical application of the principles thereof, and in which:

FIG. 1 is a perspective view of the mobile primary treatment unit of the mobile liquid treatment station of this invention with the top walking grate, inclined plate interceptor pack and lamella separators removed;

FIG. 2 is a side view of the unit of FIG. 1;

FIG. 3 is an opposite side view of the unit of FIG. 1;

FIG. 4 is a top view of the unit of FIG. 1;

FIG. 5 is a bottom view of the unit of FIG. 1;

FIG. 6 is a front view of the unit of FIG. 1;

FIG. 7 is a rear view of the unit of FIG. 1;

FIG. 8 is an illustration of throughflow at the unit of FIG. 1;

FIG. 9 is a sectional view taken through section lines 9-9 of FIG. 5;

FIG. 10 is an illustration of the unit of FIG. 1 without its side liquid containment walls;

FIG. 11 is a partial perspective view of the fluid uptake end of the unit of FIG. 1;

FIG. 12 is a sectional view taken through section lines 12-12 of FIG. 1;

FIG. 13 is a sectional view taken through section lines 13-13 of FIG. 1;

FIG. 14 is a sectional view taken through lines 14-14 of FIG. 5;

FIG. 15 is a sectional view taken through lines 15-15 of FIG. 1;

FIG. 16 is a sectional view taken through lines 16-16 of FIG. 6;

FIG. 17 is a partial perspective view of the clarified liquid output end of the unit of FIG. 1;

FIG. 18 is a sectional view taken through section lines 18-18 of FIG. 1;

FIG. 19 is a sectional view taken through section lines 19-19 of FIG. 1;

FIG. 20 is a partial sectional view taken through lines 20-20 of FIG. 1;

FIG. 21 is a partial sectional view taken through lines 21-21 of FIG. 1;

FIG. 22 is a side view illustration of the mobile treatment management unit of the mobile liquid treatment station of this invention;

FIG. 23 is a top view of the unit of FIG. 22;

FIG. 24 is an opposite side view of the unit of FIG. 22;

FIG. 25 is a perspective view of dosing cabinets and chemical storage of the unit of FIG. 22;

FIG. 26 is a schematic wiring and unit interconnections diagram of the mobile liquid treatment station of this invention;

FIG. 27 is a diagram illustrating control and feedback operations between the units of FIGS. 1 and 22;

FIG. 28 is a flow chart illustrating software control of the various apparatus in the units of FIGS. 1 and 22;

FIGS. 29A through 29I are illustrations of the process and data acquisition controls of this invention;

FIG. 30 is an illustration showing a software controller and training simulator of this invention;

FIG. 31 is another illustration of the software controller and simulator of this invention; and

FIG. 32 is yet another illustration of the software controller and simulator of this invention.

### DESCRIPTION OF THE INVENTION

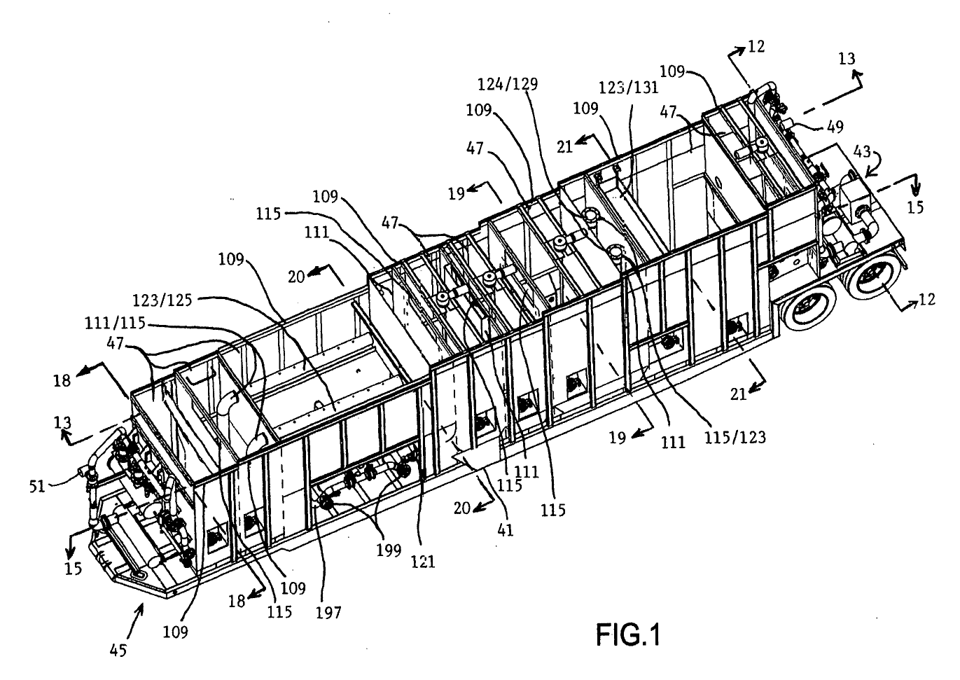

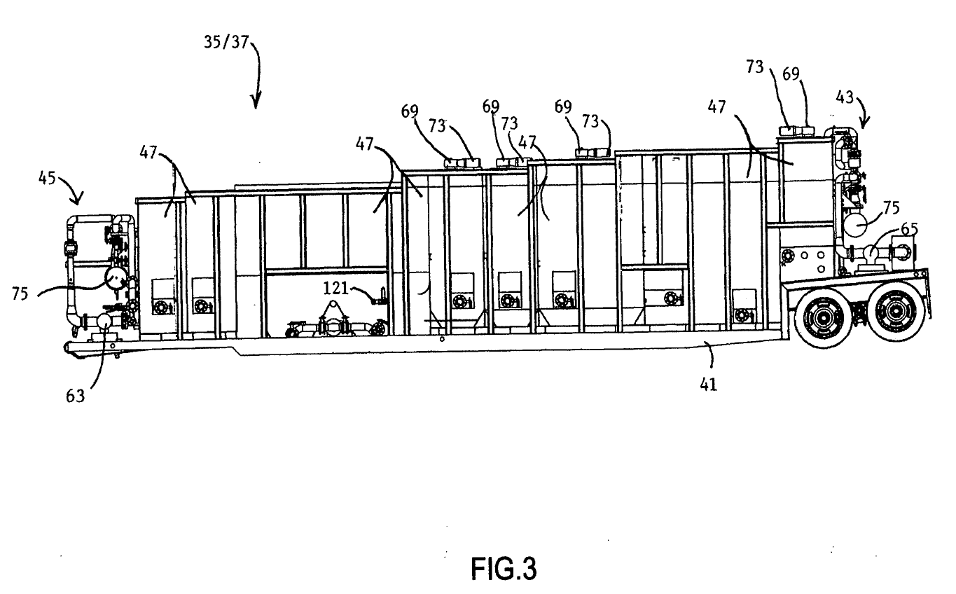

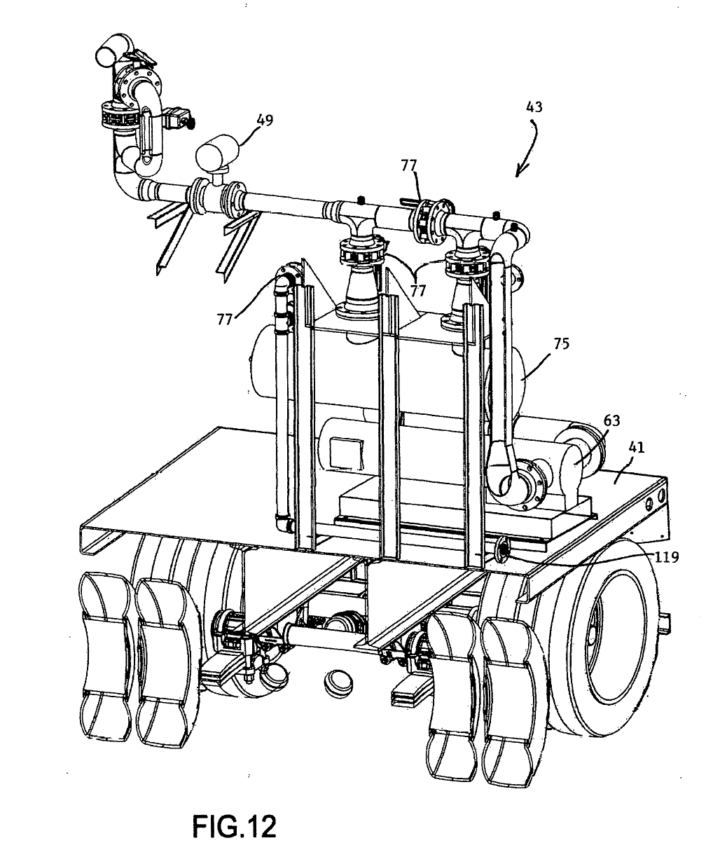

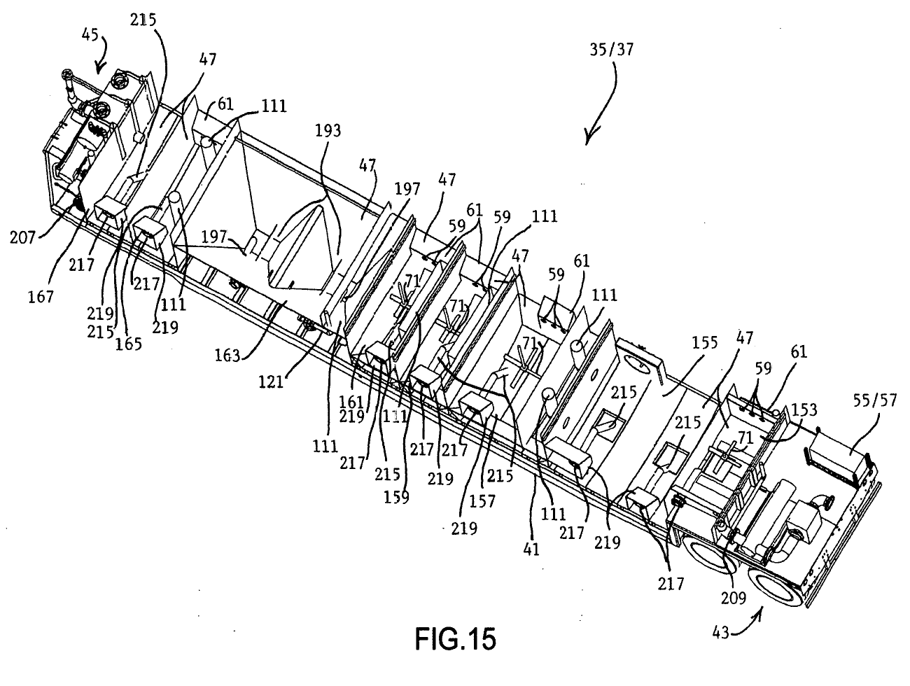

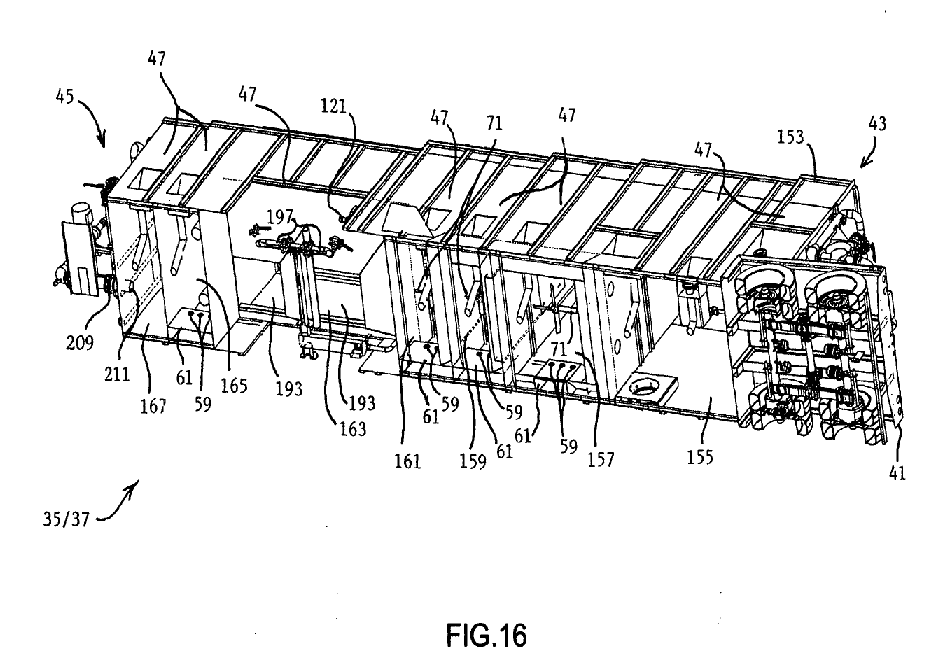

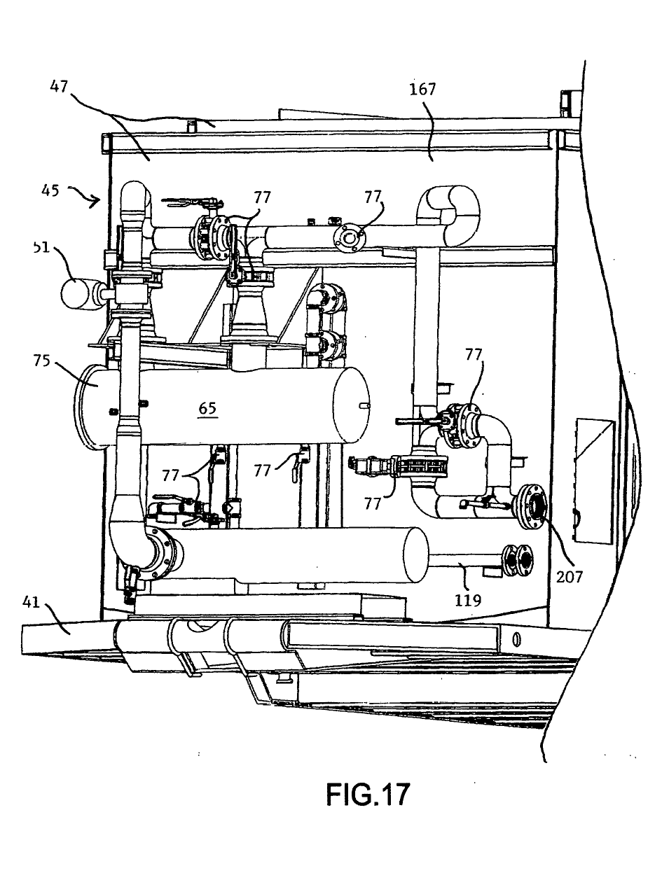

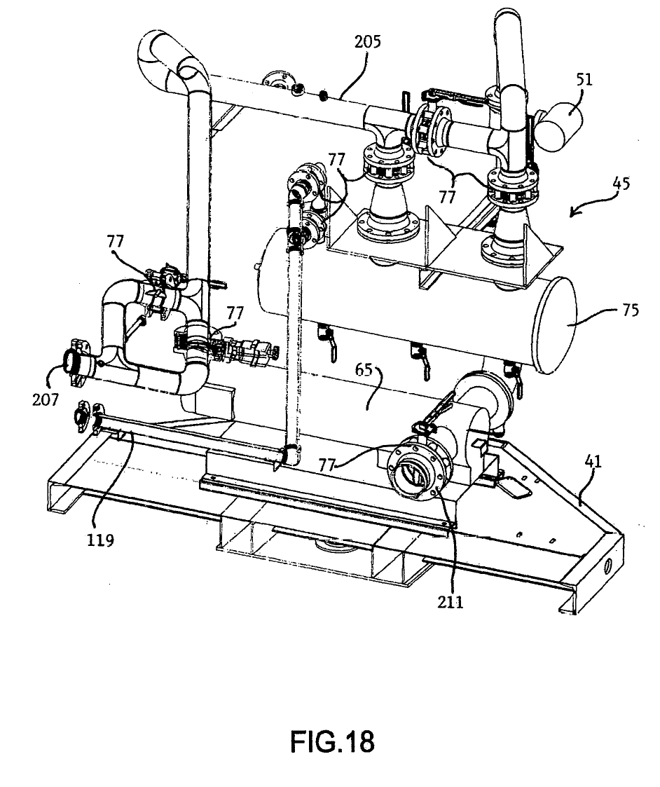

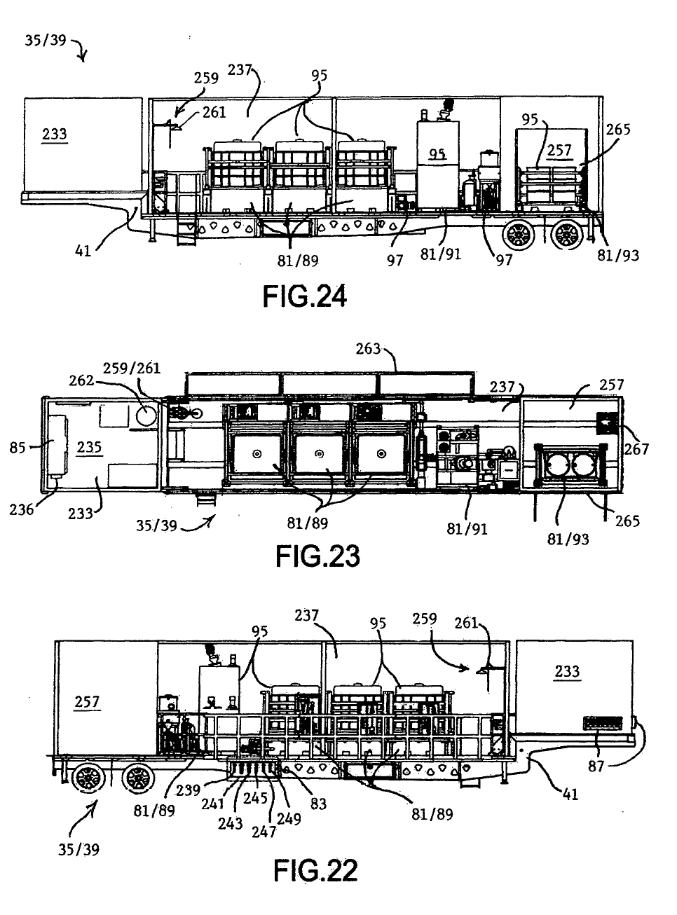

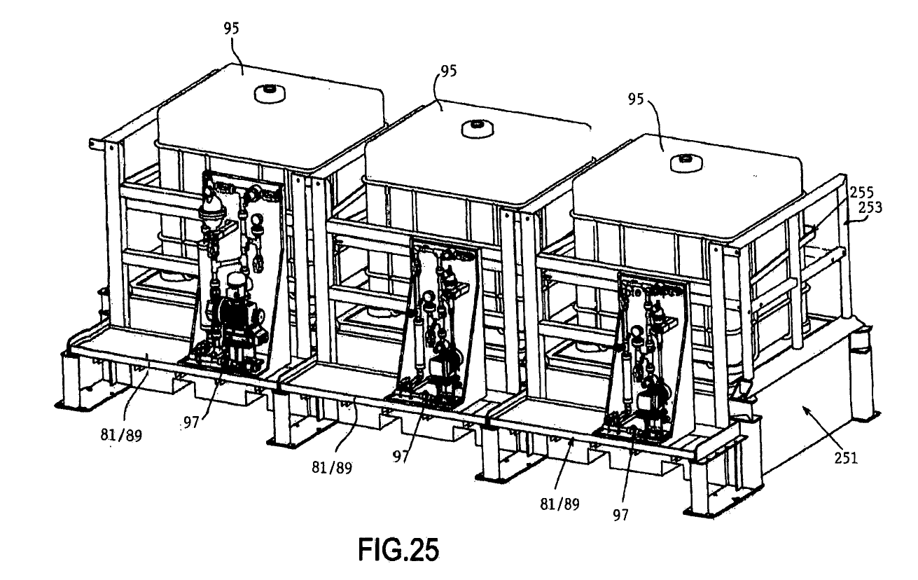

A mobile liquid treatment station 35 of this invention is illustrated in the FIGURES. The station can be used at selected sites in any number of liquid (primarily water) treatment applications, and, as illustrated herein, is well adapted for treating industrial process liquids, such as flowback water at oil and gas fracking sites. The station includes primary mobile liquid treatment unit 37 (see FIGS. 1 through 21) and independently mobile treatment management unit 39 (see FIGS. 22 through 25). Each unit 37/39 is mounted on a mobile (wheeled) platform 41, typical two axle long haul trailers, for example.

Mobile primary liquid treatment unit 37 has an intake end 43 for receipt of liquid to be treated (hereinafter “foul liquid” or “foul water”, for example fracking process flowback water) and a purified liquid output end 45 with a plurality of liquid containment and treatment compartments 47 defined and serially arranged therebetween. The compartments are dimensioned and located for promoting cascading flow and for performance of selected liquid treatment functions thereat (such as chemical dosing and mixing and solids separation as further disclosed hereinafter). Compartments 47 provide staged, sequential, chemical treatment and phase or solid separation (while any number of compartments suitable to the particular tasks at hand can be incorporated into unit 37 and fall within the scope of this invention, at least 7 compartments are particularly illustrated herein, which number is often best suited for many if not most operations, with eight being preferred including the buffer tank).

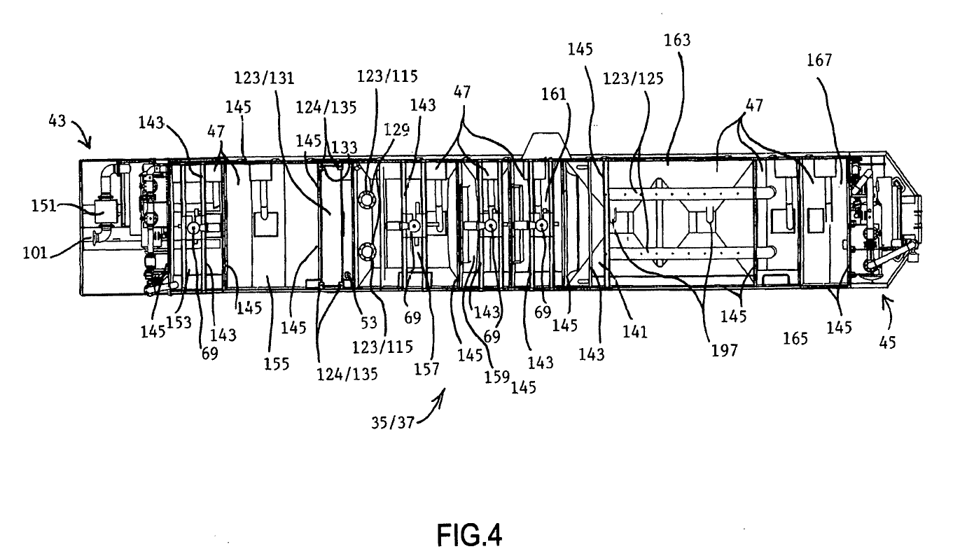

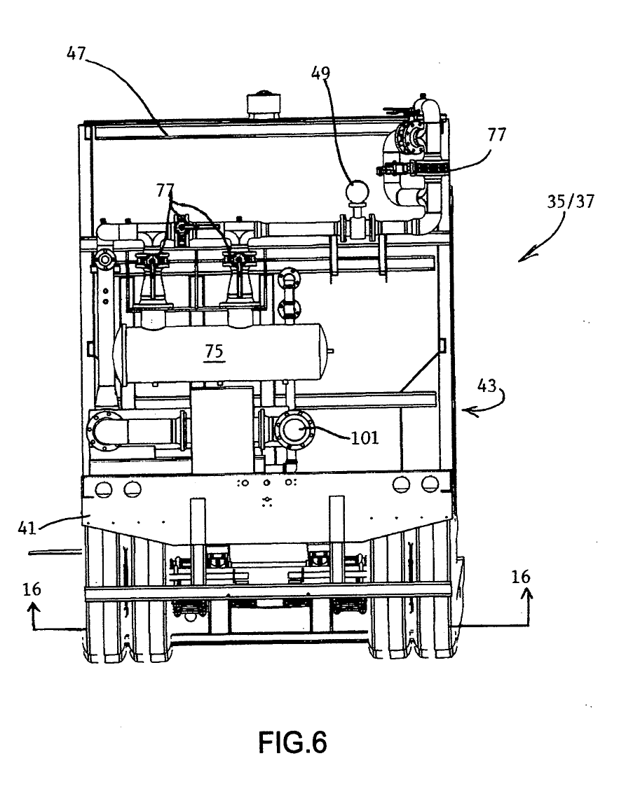

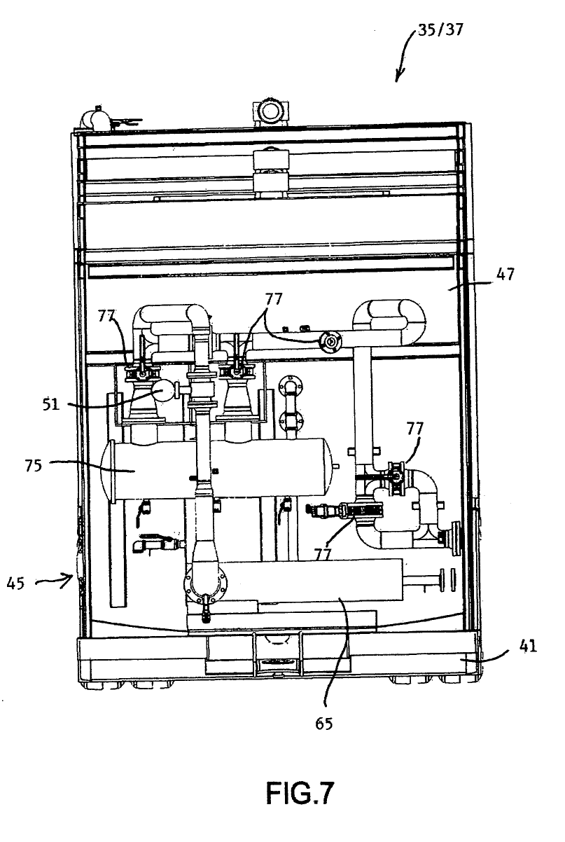

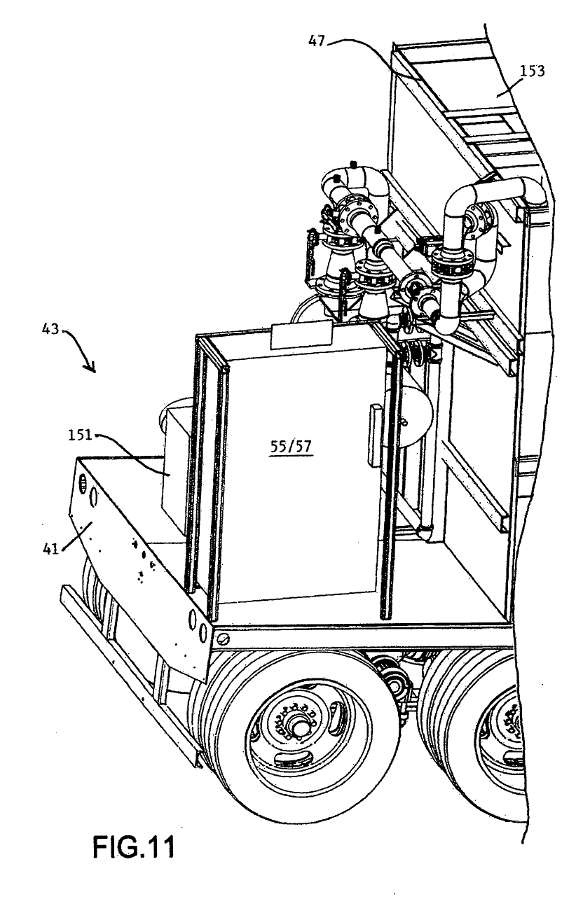

A plurality of sensors (pH meter 49 and turbidity meter 51 at intake and output ends 43 and 45, respectively, for example—see FIGS. 6 and 7) are provided and attached to sensor probes (53, for example, in FIG. 4) selectively positioned throughout the unit. Meter location and number, together with probe location, type and number, may be varied from application to application and as the treatment situation may dictate. Placement of sensors/probes early in the flow path is better suited to characterization of foul water quality, while positioning later in the path is better suited to characterization of treatment efficacy. Other sensor positioning may be particularly adapted to characterization of particular treatment functions and attributes of operational functioning of selected treatment unit components. All such sensors include output connections for electronic signal outputs indicative of sensor measurement data connected to power and data transfer terminal 55 (located in utilities box 57 as illustrated in FIG. 11).

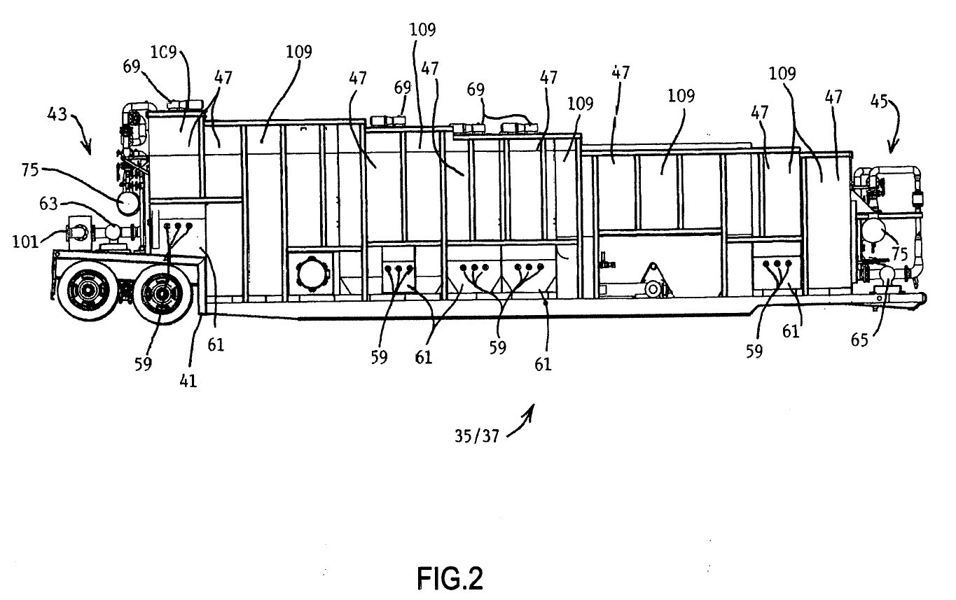

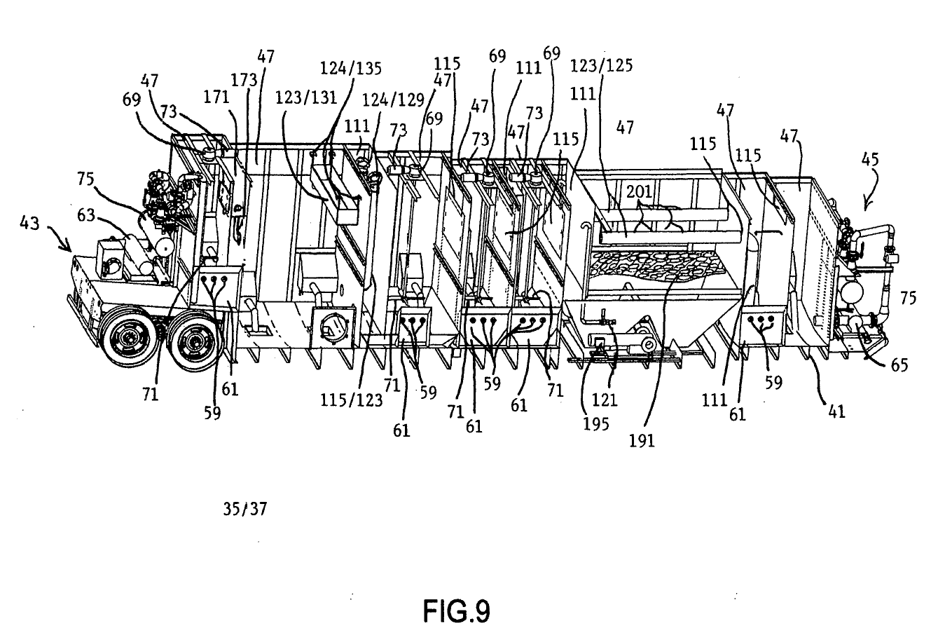

A plurality of chemical dosing inputs 59 are located at support boxes 61 (see FIGS. 2 and 9) at different ones of compartments 47. As shown in FIGS. 6, 7, 9, 12, 17 and 18, a plurality of pumps (feed pump 63 and outflow pump 65, for example,), mixers 69 (including impellers 71 connected with drive motors 73), automated back flush filter assemblies 75, and motorized/manual valves 77 having connections for operational control and feedback through terminal 55 are provided in conventional arrangement for the various functions as described hereinafter.

Independently mobile treatment management unit 39 in FIGS. 22 through 25 includes a plurality of chemical dosing platforms 81, an externally located dosing manifold 83 and a central power and processing assembly 85 serviced through externally located power and data input and output terminal 87 (as more fully discussed hereinafter). Terminal 87 may include multiple nodes (for pumps and mixers control output from connection nodes at the side of the unit, and for 120 V power, an emergency stop, an Ethernet bus for movement of control and data signals, and sensory feedback at nodes on the rear of the unit, for example). Chemical dosing platforms 81 include dosing cabinets 89, polymer storage and flocculant makeup system 91, and demulsifier storage and makeup room 93. Chemical storage 95 are connectable with a plurality of dosing pumps 97 connected with power and processing assembly 85 and having dosing outputs connected with manifold 83. A conventional bus or busses are connectable between terminal 87 at management unit 39 and transfer terminal 55 of primary treatment unit 37. Conventional chemical feed line assemblies are selectively connectable between dosing manifold 83 of management unit 39 and dosing inputs 59 at compartments 47 of treatment unit 37. Thus, as may be appreciated, dosing control, component operations and data acquisition and feedback at both units 37 and 39 are controlled and received at power and processing assembly 85 of management unit 39.

While not illustrated, station 35 of this invention employs a pressure sensor connected between power and processing assembly 85 at management unit 39 and an on-site source of foul fluid (a third party flowback receiving tank, for example) into which the sensor is inserted (via lance, for example). Fluid from the source is received at variable speed feed pump 63 through input connection 101 (FIG. 6) located at intake end 43 of treatment unit 37. Unit 37 infeed and throughflow control and monitoring may thus be based on available volume of foul fluid at the source sensed by the pressure sensor inserted thereat.

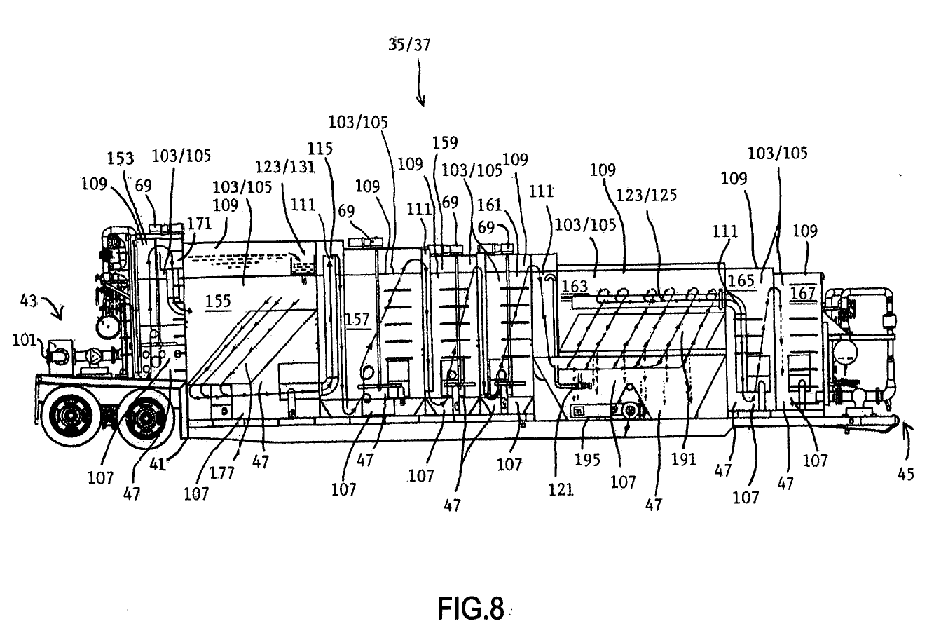

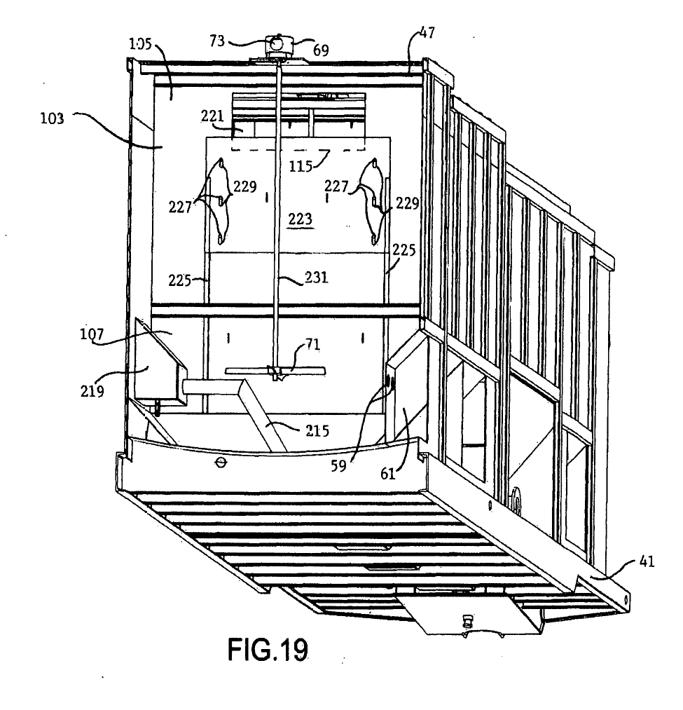

Liquid containment compartments 47 each have a volume 103 with an upper volume portion 105 and a lower volume portion 107 (see FIG. 19, for example, typical of all compartments 47 in this regard). Compartments 47 define plural serial cascade stages 109 (preferably seven, as shown in FIGS. 1, 2 and 8) between Intake end 43 and output end 45. As illustrated in FIG. 8, each stage 109 cascades from one to the next between intake end 43 and output end 45. Moreover, a majority of compartments 47 include either a diving wall or pipe structure 111 for liquid inflow at lower portions 107 of volume 103 thereof below chemical dosing inputs 59 and impellers 71 from an adjacent compartment 47, and a weir or weir pipe structure 115 (water level adjustable openings of selected size) for liquid outflow at upper portion 105 of volume 103 thereof to another adjacent compartment (see FIGS. 8 through 10 and 13 through 15). Hydrostatic pressure in the system and configuration of impellers 71 of mixers 69 promote fluid lifting during mixing (i.e. reinforcing upflow currents in compartments 47 during mixing). This over-under cascading flow design using overall unit height variation and diving walls or pipes feeding the lower portions of the compartment volumes, and with chemical injection at the lower portions of the compartment volumes, and lifting/mixing for overflow over an adjustable pipe or weir structure allows for pumpless flow between compartments with greater mixing efficacy while minimizing chemical usage.

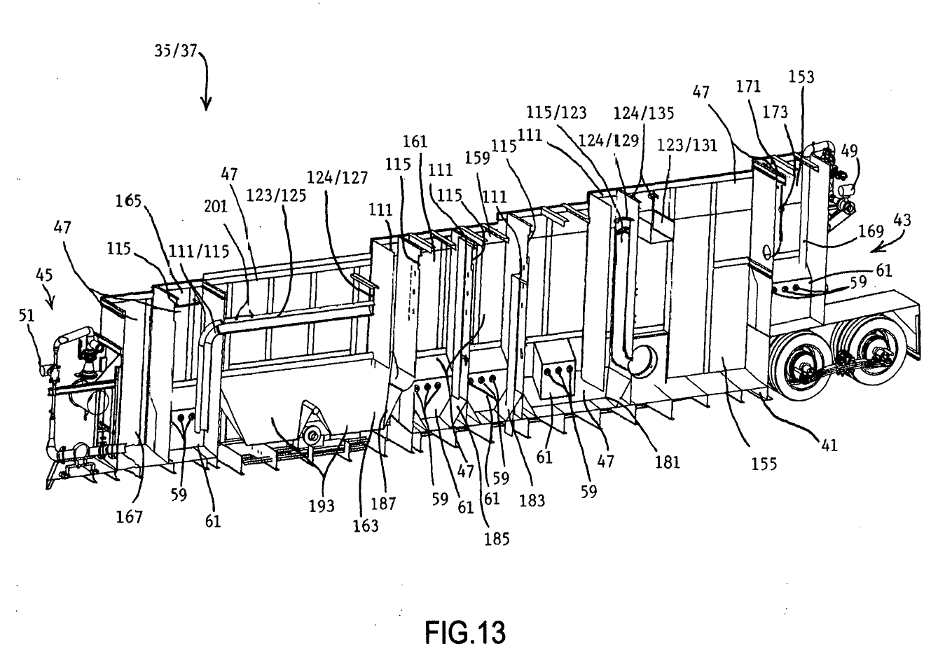

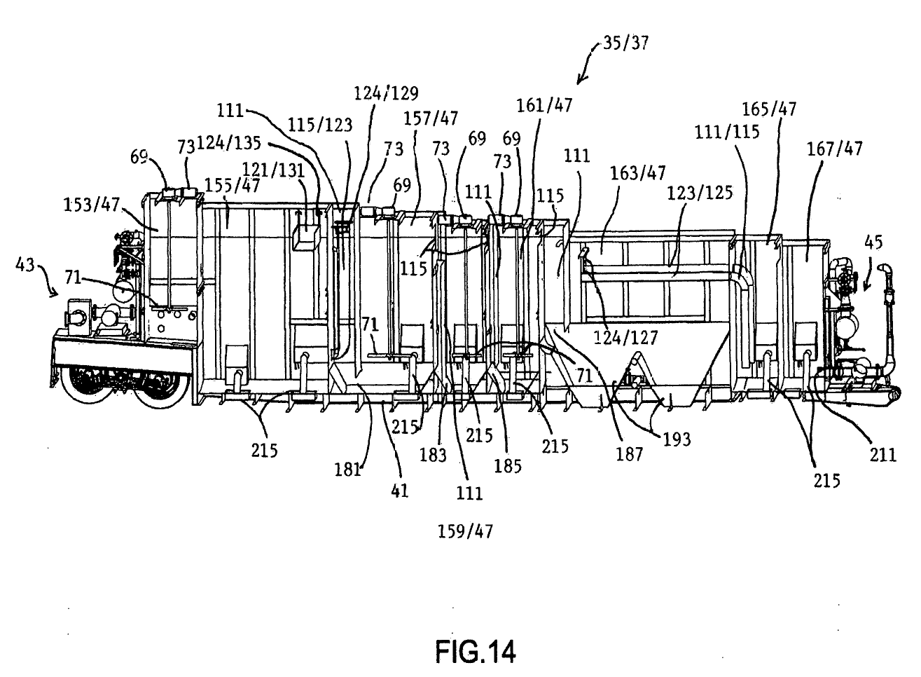

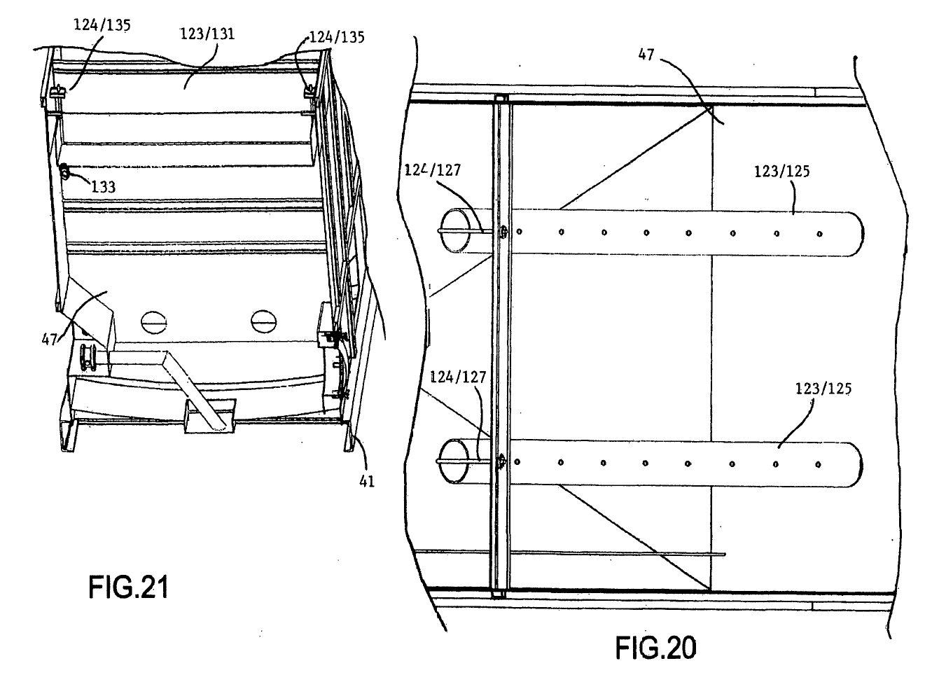

As shown in FIGS. 8 through 10, 12 and 18, back flush filter assemblies 75 both include a by-pass back flush liquid output line 119 for directing back flush liquid (using hoses) directly to input line 121 feeding into solids separation stage upon performance of a back flush. Various flow accommodating components 123 are located in compartments 47 (in addition to diving wall or pipe structures 111 and weir or weir pipe structures 115), at least some compartments 47 also including liquid flow leveling features 124 for independent internal leveling of flow accommodating components 123 located therein in both longitudinal and transverse directions. The levelling features 124 at components 123 serve to selectively compensate for unlevel location of the mobile platform at the site and thus unit 37 sloping. These components include first and second horizontally disposed clarified liquid outflow pipes 125 in a compartment 47 more adjacent to output end 45 of mobile platform 41 (see FIGS. 4 and 20), wherein the leveling features 124 include threaded or equivalent apparatus 127 far independently selectively raising and lowering a distal end of each of outflow pipes 125. Components 123 also include first and second upright pipes 115 in a compartment 47 more adjacent to intake end 43 of mobile platform 41, leveling features 124 including height adjustable fluid outlet ends 129 (i.e., weir tops) at a top portion of upright pipes 115 (see FIGS. 13 and 14). Oil separator trough 131 at one of compartments 47 and having a separated oil outlet 133 at a corner thereof is another example of the components 123, the leveling features 124 including threaded or equivalently functional apparatus 135 for adjusting tilt of the trough in both longitudinal and transverse directions (see FIGS. 4 and 21).

Mobile liquid treatment station 35 employs chemically enhanced oil/water separation, coagulation, pH-buffering, flocculation and settling for onsite treatment of industrial process water such as flowback water, for example, for the purpose of onsite or nearby site reuse. The multi-compartment cascading tank unit 37 of station 35 is used in a selective sequential treatment train controlled from management unit 39 of station 35 which also houses chemical treatment dosing apparatus and supplies.

For on-site operation in an oil/gas fracking process, additional equipment is needed for operation and completion. These include a mobile dewatering system (a centrifuge, screw press or filter press, for example), a solids containment unit, an effluent catch tank with return pump, connection hoses and power cords, a 3-phase generator for all of the above (100 kW for example, depending on the equipment), a diesel fuel tank, a fresh water tank, and a flowback storage tank. These are generally provided by the site operator or a contract service company.

Onsite flowback tanks are used for the storage of flowback water, where several frack tanks are connected together. At manhole cover level, above the tank bottom, an effluent conduit is located to minimize suspensions in the feed to mobile treatment unit 37. The effluent conduit is provided with a hydrostatic pressure sensor attached to a manhole cover or other designated outlet from the storage tank. Sensor output signals are linked to processing assembly 85 of management unit 39. The tank outlet is then connected to treatment unit 37 by a flexible suction hose. The pressure sensor measurement signals are utilized for control of feed into treatment unit 37 based upon the volume of flowback fluid remaining in the tank. Withdrawal of the flowback fluid from the tank for receipt by treatment unit 37 is controlled by the process control software program at assembly 85. The flowback tank need not be modified. The pressure sensor is preferably designed to be inserted into the flowback tank with a lance, but could be directly attached to one of the tank's available suction or discharge valves via a quick disconnect such as a CAMLOK fitting.

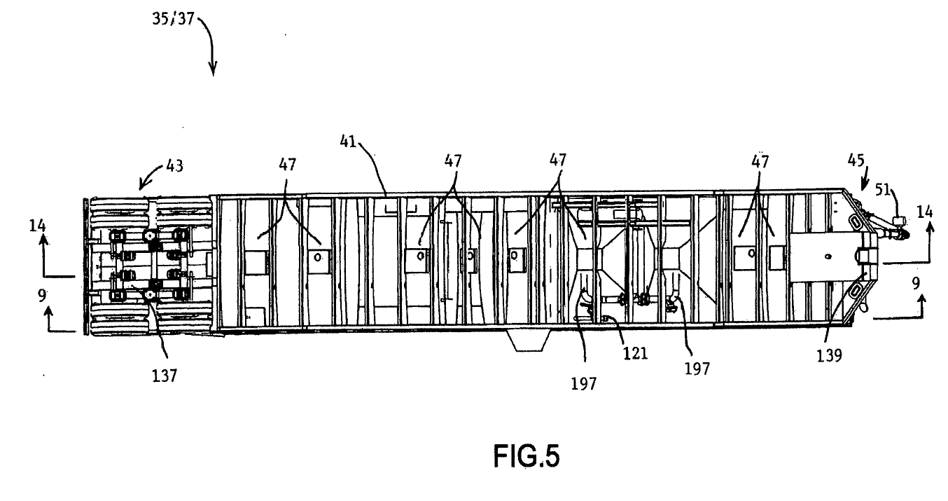

For a flexible flowback treatment process, treatment unit 37 is configurable with at least seven different serially arranged treatment compartments 47 (preferably eight). Pre-treatment and post-treatment equipment is located at intake end 43 and output end 45, respectively, on platform 41, with pre-treatment equipment situated above the trailer's double axle assembly 137 and post-treatment equipment located above the trailer's hook-up king pin area 139 (FIG. 5). Pre-treatment and post-treatment equipment consists of specific pumps, filters, flow control devices (motorized and manual valves, for example) and process control instrumentation.

Unit 37 for use in flowback treatment is preferably constructed from A36 low carbon steel and coated inside with an epoxy resin for protection from corrosion. Polyurethane paint is used on the outside of the unit for protection from oilfield use. All flowback processing pipe spools and adjustable weirs are constructed from 300series stainless steel to resist corrosion from high salinity flowback water. All chemical injection pipe spools, except the demulsifier pipe spool, are constructed from schedule 80 UV stabilized PVDF or other non-corrosive material. The demulsifier pipe spool is constructed from 316L stainless steel. While not shown, the open top 141 of unit 37 of the unit is covered with a removable, worker supporting grating resting on cross members 143 and tank walls 145 also supporting various equipment such as mixers 69, for example (see FIG. 4). Handrails, which are folded down during transport, are provided at the grating. Access for inspection, maintenance and repair of unit 37 is preferably provided through designated grating doors, manholes and access ports.

Because of the wide range of the flow rate (6 m³/h to 60 m³/h) and the wide discharge head range (0.1 bar up to 3 bars), feed pump 63 is preferably a positive displacement, variable speed rotary lobe pump for feeding flowback water received at input connection 101 to unit compartments 47, the speed of which is controlled by the readings from the hydrostatic pressure sensor in the flowback tank. The variable speed of the pump accommodates continuous feed, which prevents liquid freezing and allows downstream chemical injection equipment to operate on a continuous basis. The process controlled continuous feed of chemicals allows operation without resetting chemical feed rates. Feed pump lobes are preferably coated with VITON, and pump 63 preferably meets explosion-proof (XP) requirements, particularly the variable frequency drive (VFD) motor thereof. In comparison with other pumps, maintenance of the rotary lobe pump is simple since all wetted parts can be replaced through the front never thereof without disconnecting pipes.

Turning now to FIGS. 4, 8, 9 and 11 through 18, specific components and functions of unit 37 of station 35 will be addressed in greater detail. In order to eliminate larger solids in the feed water, strainer 151 is interposed between input connection 101 and feed pump 63. Back flush filter 75 eliminates or minimizes finer solids, and an automated back flush filter, such as a VAF 1000 with a mesh size of 500 μm, is preferable. Back flushing starts when the pressure drop over the back flush filter exceeds 0.4 bar as sensed and provided as feedback to process controls at processing assembly 85 of management unit 39. Filter back flush requires a water volume of about 0.1 m³. As noted, back flush water is either conducted back to the flowback storage tanks or, preferably, to sludge separation compartment 47 by discharge hoses.

The size of the back flush filter may be modified by changing screen size. Process control software continuously receives data which permits development of programming for optimizing screen size best suited for a particular category of flowback fluid. Flowback fluid characteristics will be similar when common fracking fluids are used in common geological formations. Optimum screen size information can be based, for example, upon back flush frequency.

In serial order, compartments 47, and thus defined stages 109, include emulsion breaking compartment 153, oil separation compartment 155, chemical dosing and polymer treatment compartments 157, 159 and 161, solids separation compartment 163, and final dosing compartment 165. A buffer compartment 167 is provided at output end 45 for flow control purposes. Emulsion breaking compartment 153 preferably has a volume of about 5.73 m³. Flowback water is conducted through diving pipe 169 into compartment 153 into which a demulsifier is dosed from management unit 39 through dosing inputs 59. The specific dosing rate of the demulsifier is about 0.5 l/m³. For mixing, a worm drive top-entry mixer 69, such as a BURHANS-SHARPE mixer, with a VFD-motor 73 is used. The speed of the mixer is about 90 rpm for most operations. A hydrofoil impeller 71 preferably has a diameter of about 28 inches to avoid settling of solids. To avoid an increase of the oil layer on the water surface in compartment 153, treated water passes over stationary weir trough 171 and through pipe(s) 173 into compartment 155. A heater may be provide at compartment 153 and is controlled automatically by measurement of oil content on the fly. Grab samples are analyzed in a lab facility provided at management unit 39 to measure hydrocarbon content and the extent of emulsification. From the sample data, and with continuous pH and turbidity measurements, software is developed to control the rate of demulsifier injected and the mixing intensity delivered by the variable frequency drive motor controlled mixer motor 73. As with all chemicals used, data acquisition software at processing assembly 85 will also keep a record of the amount of demulsifier used. In the embodiment illustrated, compartment 153 has a length of about one meter, a width of about 2.4 m, and a weir level of about 3.1 m from datum level.

Oil separation compartment 155 for oil and grease separation as shown in this embodiment preferably has a volume of about 18.12 m³. Oil and grease are separated from the pre-treated flowback liquid by a cocurrent (downflow) inclined plate interceptor pack (IPI) 177, such as a PIELKENROD IPI, conventionally positioned in compartment 155 as illustrated in FIG. 8. IPI plate pack 177 material is preferably glass-reinforced epoxy. IPI plate pack 177 has a plate distance of about 20 mm, and the plates are set at an angle of about 45 degrees to the horizontal. Plate pack 177 arrangement has a total installed surface area of 175 m² so that oil droplets greater than about 50 μm and solids greater than about 20 μm are separated at the maximum flow rate of 60 m³/hr.

Oil is collected in oil trough 123/131 adjusted for location at the fluid surface level in the compartment as hereinabove disclosed at four points to accommodate oil entry at the volume of water's top and oil draining from the trough through outlet 133 regardless of level of unit 37 at the site. The oil and grease free water is conducted through upright pipes 115/123 from below IPI plate pack 177 into the top of intervening diving structure 111, fluid levelling from pipes 115/123 adjustable at weir tops 124/129 in order to control the fluid level height in compartment 155 and to compensate for the slope of treatment unit 37 in the longitudinal and transverse directions as positioned at the site. Diving structure 111 has an outlet opening 181 at the bottom thereof into compartment 157. In the embodiment illustrated, compartment 155 has a length of about 2.5 m, a width of about 2.4 m, and an oil trough level of about 3 m from datum level.

Compartment 157 is primarily for dosage of coagulants, particularly metal ion base coagulants, through one of dosing inputs 59 and preferably has a volume in the embodiment illustrated of about 14.3 m³. The typical expected dosing rate of coagulants is approximately 2l/m³. The specific dosing rate is dependent on the type of coagulant and the constitution of the flowback. For mixing the coagulants, worm drive top-entry mixer 69 is preferred with VFD-motor 73 for high speed mixing. Hydrofoil impeller 71 in such case has a diameter of about 32 inches used to avoid settling of solids. Compartment 157 also accommodates pH level adjustment to optimize the coagulants to their maximum efficiency by dosing acid or caustic. The type of pH buffer dosing, acid or caustic, is dependent upon the type of coagulant used, such as an aluminium ion or ferric ion based coagulant. Each coagulant has its own optimum pH range in which it is effective as a coagulant, for example pH 6.0-7.5 for aluminium ion or pH 4.5 to 7.5 for ferric ion. The pH level is measured by pH sensor 53 (FIG. 4). The treated water passes over adjustable weir 115 and via diving wall structure 111 into the lower portion of compartment 159 through outlet opening 183. In the embodiment illustrated, compartment 157 has a length of about 2 m, a width of about 2.4 m, and a weir level of about 2.7 m from datum level.

Compartment 159 in the embodiment illustrated is for adjusting the pH level and has a volume of about 6.2 m³. The pH level is adjusted by dosing acid or caustic if needed through one of dosing inputs 59 to accommodate the type of polymer used in compartment 161. For proper blending, worm drive top-entry mixer 69 with a VFD motor 73 is used. Speed of the mixer is about 90 rpm. Hydrofoil impeller 71 with a diameter of about 28 inches is used to avoid settling of solids. Process water passes over adjustable weir 115 into the lower portion of compartment 161 through opening 185 at the lower part of diving wall structure 111. In this embodiment, compartment 159 preferably has a length of about 1 m, a width of about 2.4 m, and a weir level of about 2.7 m from datum level.

Compartment 161 is for dosage of polymer flocculants and in the embodiment illustrated preferably has a volume of about 6.2 m³. Water soluble, synthetic and/or organic polymers are added through one of dosing inputs 59 as coagulants or flocculants in compartment 161. For selection of a suitable polymer, molecular weight, charge type, charge density and product form need to be considered and tested prior to full-scale application. The expected dosing rate of the flocculants at 0.1% concentration is about 10 l/m³. The specific dosing rate is dependent on polymer product and flowback water quality. For mixing the polymer with the flowback water, worm drive top-entry mixer 69 with a VFD motor 73 is preferably used. The rotary speed of the mixer is adjusted to minimize shear of the floc structure. Hydrofoil impeller 71 with a diameter of about 32 inches is preferred to avoid settling of the flocculated solids. The flocculated flowback water suspension passes over adjustable weir 115 into compartment 163 via diving wall structure 111 through opening 187. Efficiency of the polymer treatment is sensed and reported at turbidity meter 51. In this embodiment, compartment 161 preferably has a length of about 1 m, a width of about 2.4 m, and a weir level of about 2.7 m from datum level.

Compartment 163 is for solid separation and sludge removal and in this embodiment preferably has a volume of about 15.9 m³. Flocculated solids (sludge) are separated by a lamella separator assembly 191 (partially illustrated in FIG. 9). The solids phase of the flocculated flowback water suspension is precipitated out from the liquid phase in this compartment, with enhanced precipitation provided by use of a counter current (upflow) lamella tube settler 191 such as a DEGREMONT separator from HAGER+ELSASSER. The material used in construction of this lamella tube settler is polyethylene, the lamella pack in this case having a total height of about 650 mm and a lamella slope angle of about 60° to the horizontal. In the embodiment illustrated, the preferred length of compartment 163 is about 3.6 m, with a width of about 2.4 m, and a weir level of about 2.7 m from the datum level.

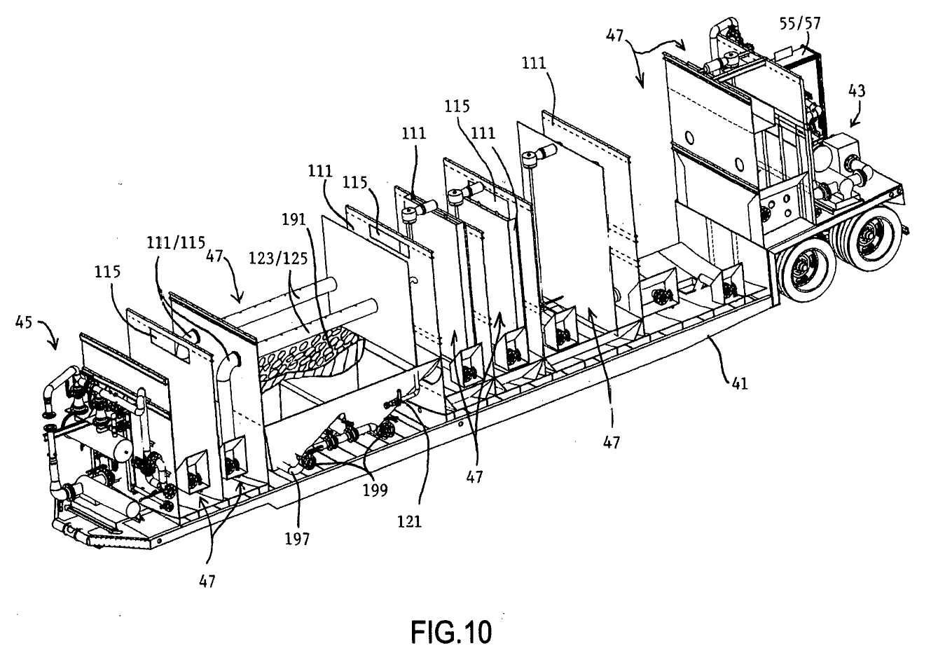

The precipitated sludge settles out into two tapered (trapezoids) sludge cones 193 located under the lamella separator, where it is further compressed by gravity (a dual separation and concentration cone device). The settled sludges are pumped by means of variable speed rotary lobe pump 195 through cone outlet piping 197 and outlet connections 199 to a dewatering unit for solid/liquid separation. Clarified dewatered effluent from the dewatering unit can be returned to compartment 163 through input line 121 (using flexible hose—see also FIG. 10). Clarified water leaves compartment 163 through two outflow pipes 123/125 positioned horizontally above lamella separator assembly 191. These outflow pipes avoid taking in solids through the pump suction cone which occurs when using typical suction pumps, and are adjustable to take uneven site location into account as disclosed above. Each pipe 123/125 has a plurality (15 preferably) of 1 3/16 inch holes 201 at their tops providing water intake in a calm, clarified liquid region just below the liquid level in the compartment (i.e., the pipes are fully submerged) thus avoiding water surface contamination accumulations from being transferred together with the clarified water to the next compartment/stage. Because of the height difference, pipes 123/115 are submerged, even if the flow rate is very low.

At their outlet ends, pipes 123/125 provide diving pipes 115/111 to transport the clear fluid into compartment 165. This arrangement overall eliminates or greatly reduces fine solids not separated out in the lamella separator 191 by requiring the clear water to circulate to the top of comportment 163 and through holes 201 in the tops of the pipes 123/125. As noted heretofore, back flush sludge from back flush filter 75 bypasses compartments 153 through 161 and is introduced into compartment 163 through input line 121 emptying into the top of adjacent intervening diving wall structure 111.

Diving pipes 115/111 from compartment 163 dive down to approximately one foot above the bottom of compartment 165. Compartment 165 as shown in this embodiment has a length of about 0.9 m, a width of about 2.4 m, and a weir level of about 2 m from datum level providing a volume of about 4.9 m³. Compartment 165 is utilized for again adjusting the pH of the clarified liquid if needed using acid or caustic introduced through one of dosing inputs 59. Optionally, a biocide could be dosed into compartment 165 through one of dosing inputs 59 to eliminate or greatly retard the re-proliferation of harmful organisms, e.g., sulphur reducing bacteria (SRB), in the treated flowback. Output from compartment 165 is through weir 115 (preferably adjustable) into flow buffer compartment 167.

Installation of a mixer could be accommodated but, for most applications, is not necessary because dive pipes 115/111 create their own mixing energy and because mixing is provided through outflow pump 65 at output end 45 of platform 41. Efficacy of the pH level is measured at a sensor (for data acquisition and further dosing adjustment) in effluent pipe 205 leading to purified liquid output connector 207 after passing through compartment 167.

Compartment 167 in the embodiment illustrated preferably has a volume of about 4.9 m³, and serves as a buffer tank for variable speed effluent pump 65 and is equipped with dry run and overfill protection. Valved outlet piping 209 carries the purified liquid between compartment outlet opening 211 and pump 65. In the embodiment shown, compartment 167 has a length of about 0.9 m, a width of about 2.4 m, and a weir level of about 2 m from datum level.

As may be appreciated, individual compartments 47 may be bypassed. Each dosing compartment has triple injection inputs 59 to accommodate different chemicals. Because of the wide range of the flow rate (6 m³/h to 60 m³/h) and the wide range of the discharge head (0.1 bar up to 3 bars), a positive displacement outflow pump 65, such as a rotary lobe pump, is preferred. The lobes of the pump are coated with VITON. The whole pump meets XP requirements, particularly the VFD motor. The speed of the pump is controlled by sensed or calculated fluid level in compartment 167.

In order to eliminate or greatly reduce suspended solids, an automatic backflush filter 75 (for example, a VAF 1000 with a mesh size of 100 μm) is provided at output end 45. Back flushing starts when the pressure drop over the back flush filter exceeds 0.4 bar. The back flush fluid is conducted using flexible hose to either the dewatering unit or to solids separation compartment 163 through Input line 121 emptying into the top of adjacent intervening diving wall structure 111. Each backflush needs a volume of about 0.1 m³ of liquid. Outgoing water quality is measured and recorded as discussed hereinabove, and overall treatment efficiency is measured by backflush frequency.

Turning now to FIGS. 14, 15 and 19, compartment drains 215 are provided at each of compartments 153, 155, 157, 159, 161, 165 and 167 for solids collection and final or emergency draining of unit 37 through drain outlet connections 217 held at mounting boxes 219. The sludge in compartment 163 is removed continuously as previously noted. Adjustable weirs 115 each include opening 221 and weir plates 223 in tracks 225 held on pegs 227 in slots 229 (see FIG. 19, all weir structures herein being of similar design except for the pipe weirs used). The fluid levels in the individual compartments are fixed by the adjusted level of their weirs. All mixers 69 include shafts 231 for imparting rotatary motion to impellers 71.

When placed at a site, flow adjustments are made by manipulation of internal levelling of components for proper operation of unit 37. These include oil trough 123/131, individual effluent pipe weirs 124/129, and individual effluent pipes 123/125 end heights. It is not necessary to adjust the adjustable weirs between the compartments to compensate for onsite slope of flowback unit 37 but only for flow balancing.

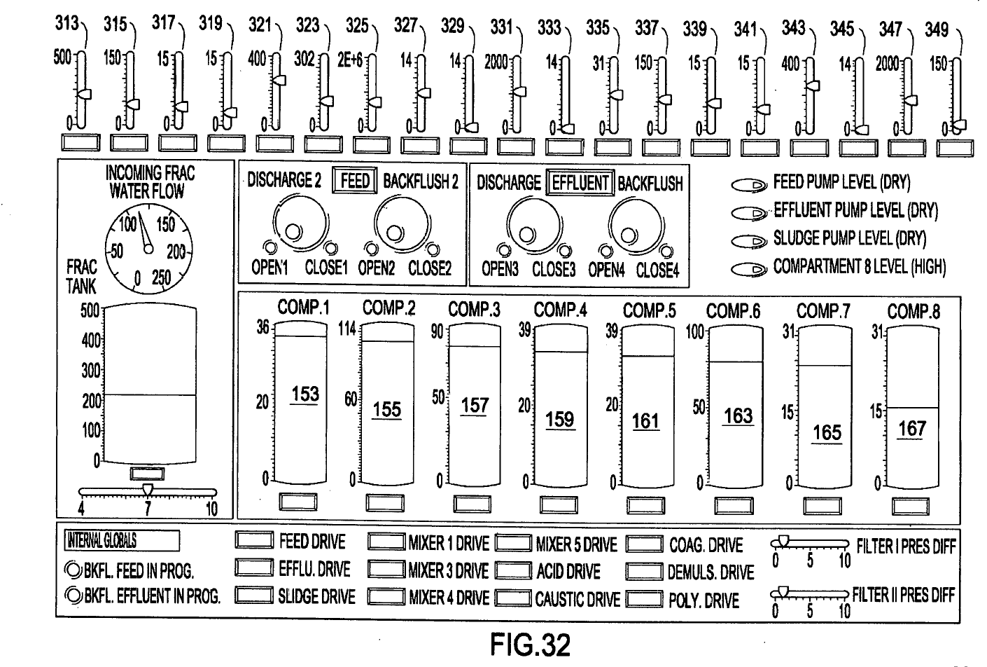

A more detailed examination of management unit 39 of station 35 is now undertaken with reference to FIGS. 22 to 25. Treatment controller center 233 is located on platform 41 and houses central power and processing assembly 85 therein as well as auxiliary function lab center area 235 and networking facility 236 (resident with assembly 85). Assembly 85 of controller center 235 includes both manual and automated switching controls (see FIG. 32, for example) and supports a programmable controller or controllers. Remotely accessible control output and feedback input terminal 87 is located on an outer wall thereof for operative association with unit 37. Chemical dosing control center 237 is located adjacent thereto on platform 41, includes dosing platforms 81 thereat, and is operatively associated with assembly 85 at controller center 233. Remotely accessible chemical dosing and fluids output manifold 83 is located at platform 41 therebelow. Manifold 83 includes demulsifier output 239, water supply output 241, polymer output 243, caustic output 245, acid output 247 and coagulant output 249. Dosing platforms 81 are defined at primary platform 251 including storage securement railing and brace assembly 253 and tote securement straps 255 all for locating and securing cabinets 89 and chemical storage totes 95 thereat. Demulsifier storage room 257 on platform 41 is for storage of demulsifier chemicals. Auxiliary functions shower and eye wash center 259 is located at one end of center 237 and includes shower 261 fed from water supply 262. An overhead folding door 263 accesses unit 39 and secures the unit for movement.

For the treatment of flowback water, different chemical additives can be employed and pumped from management unit 39 to treatment unit 37. The chemical treatment product categories include emulsion breakers, coagulants, polymer flocculants, acids, caustics and biocides. While only a single polymer system is shown, an additional polymer system could be provided. For the dosing of polymer, a two tank system is shown (a three tank system could be utilized) using a dry polymer feeder and water intake for make-up of polymer solution from water and dry polymers at unit 39. While not shown, a liquid polymer dilutions system is also provided.

Each dosing cabinet 89 has one or two dosing pumps (for example, from PROMINENT). The dual dosing pump option per dosing cabinet allows for the dosing of two different chemicals through one dosing cabinet. The pipe spool fittings, valving and special flow parts are made of compatible synthetic material with FEP seals for dosing flocculants, acids, caustics and the like. Because emulsion breaker chemicals can form an explosive and/or hazardous atmosphere, the chemical containers and dosing cabinet therefore are placed in a separate, air conditioned room 257 having a separate access 265. Explosimeter 267 monitors the atmosphere in room 257. The piping and associated components of the dosing cabinet therein are made of 300 series stainless steel. The emulsion breaker flow rate is controlled by the flow rate of the flowback water under process control.

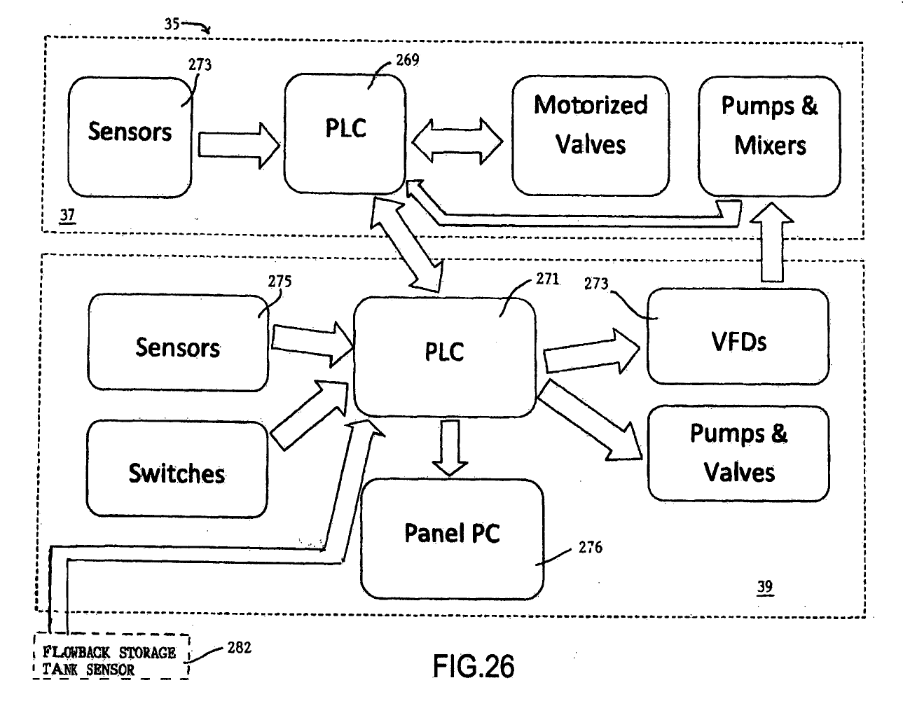

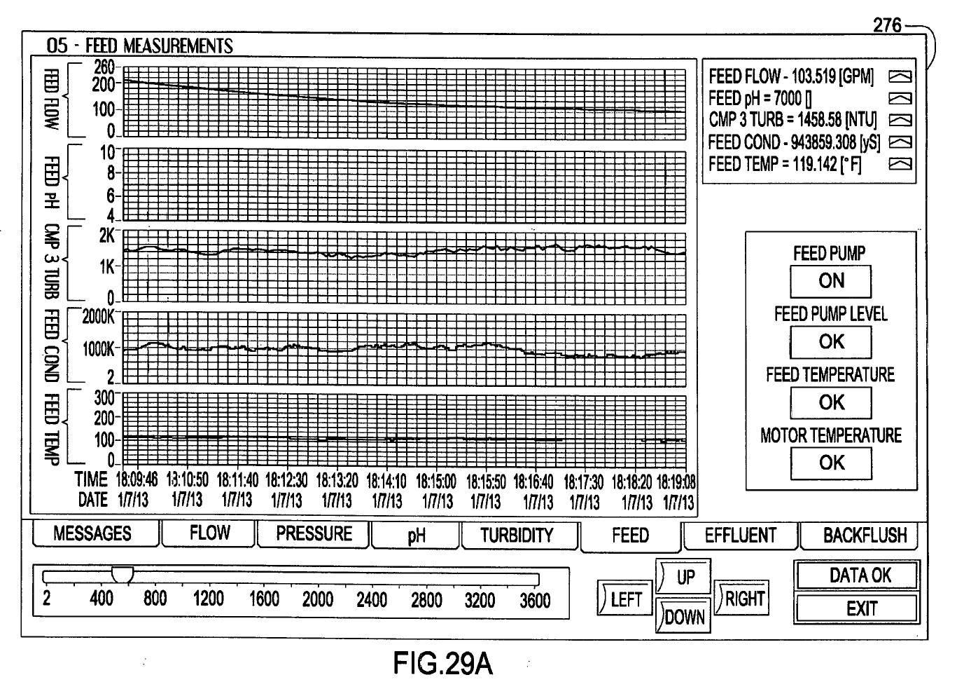

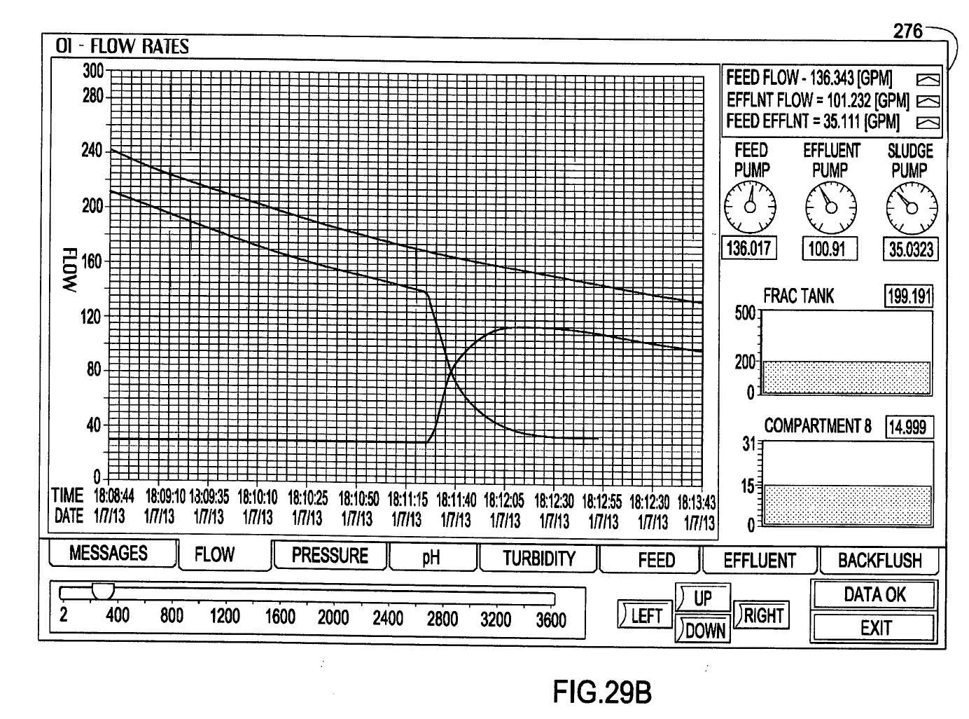

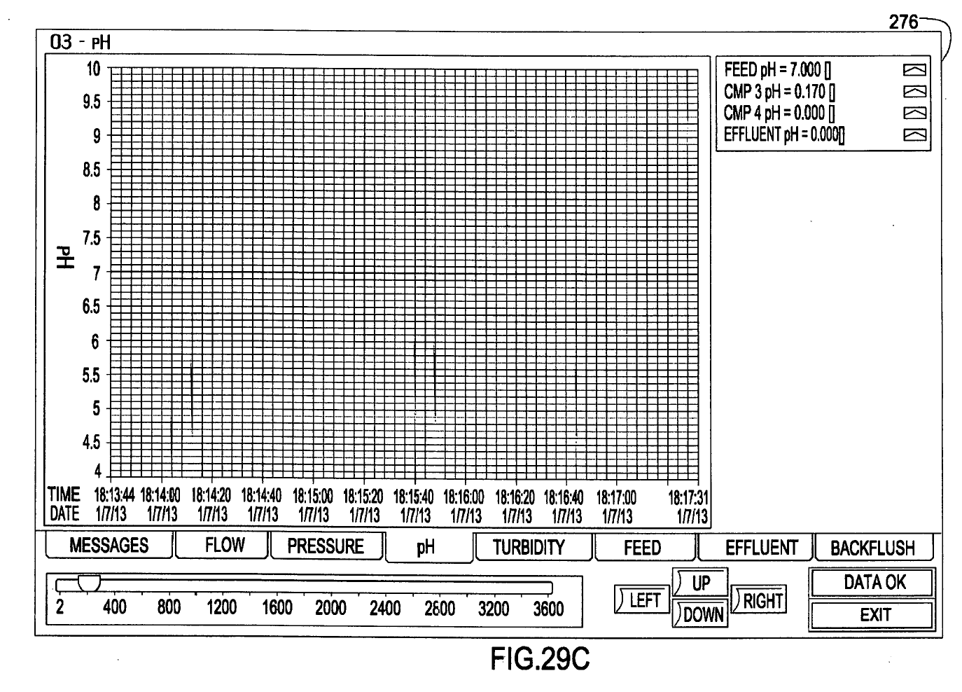

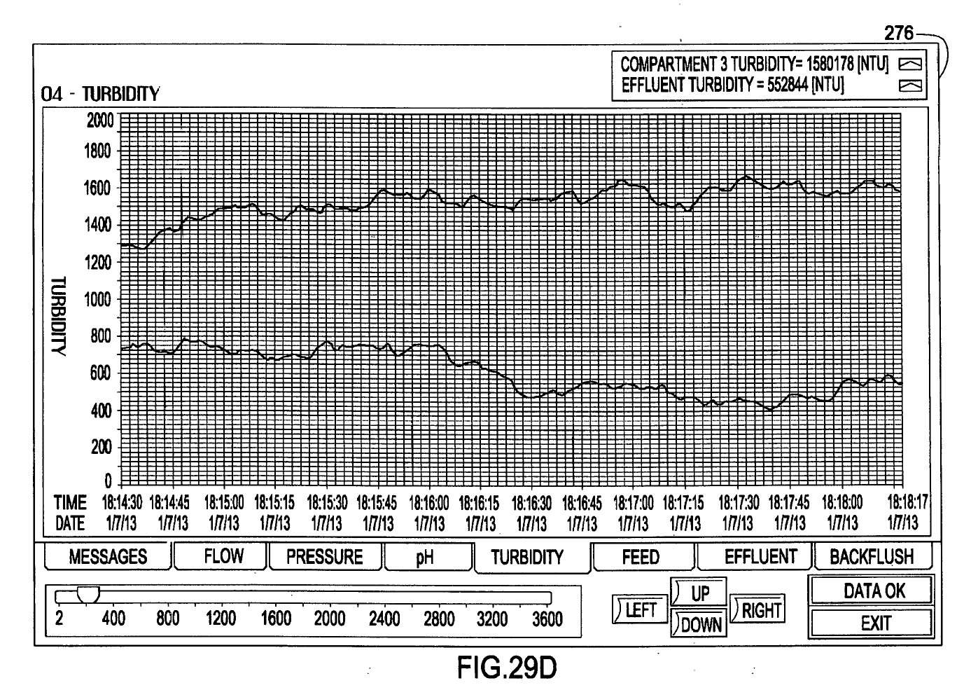

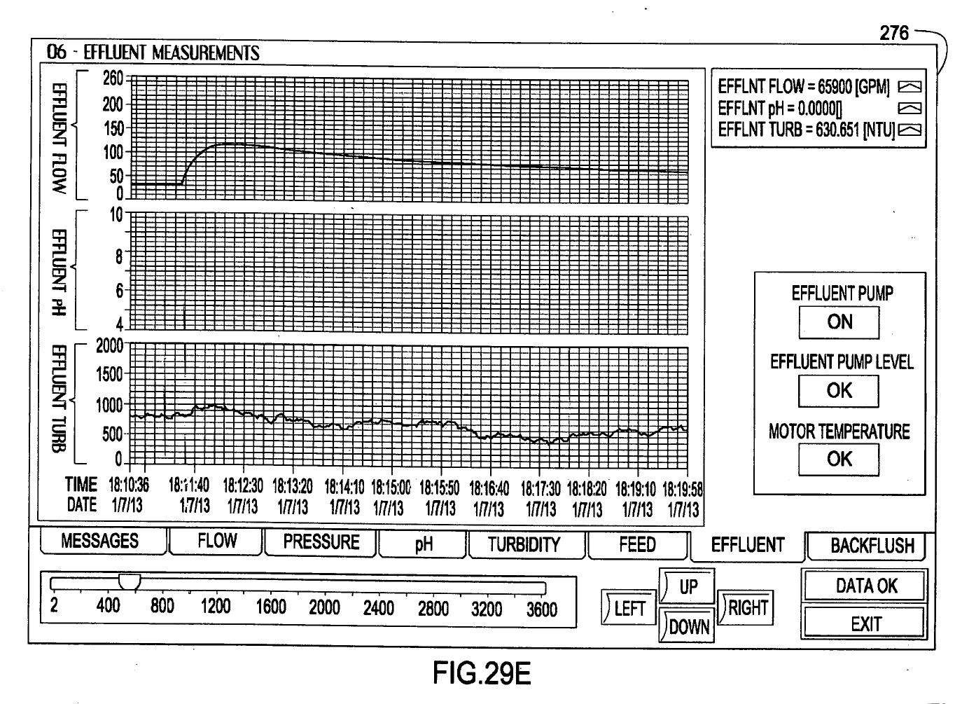

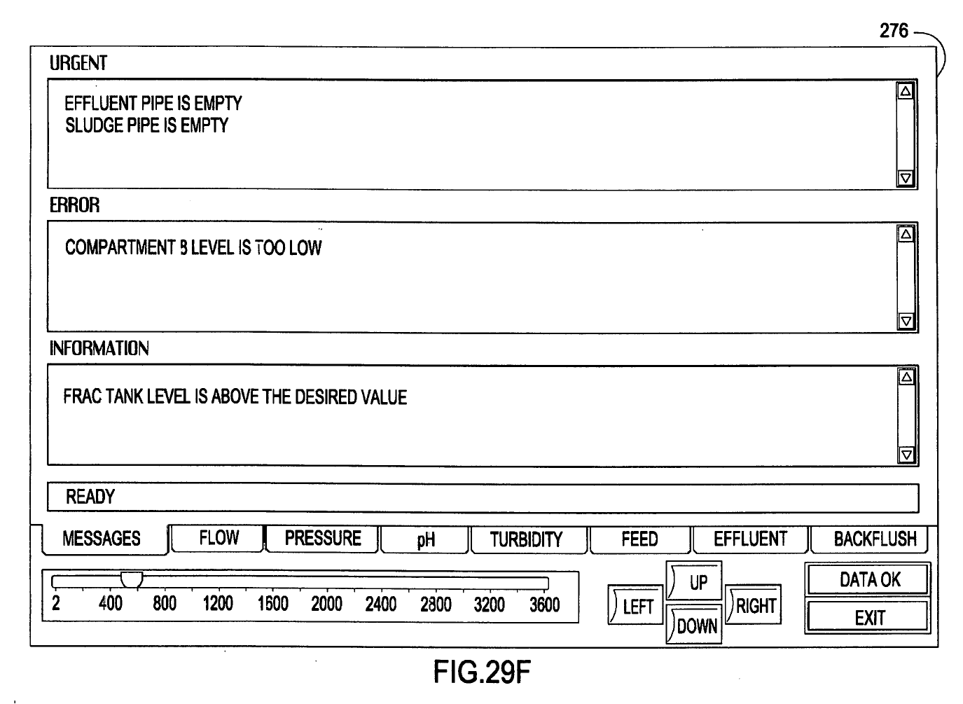

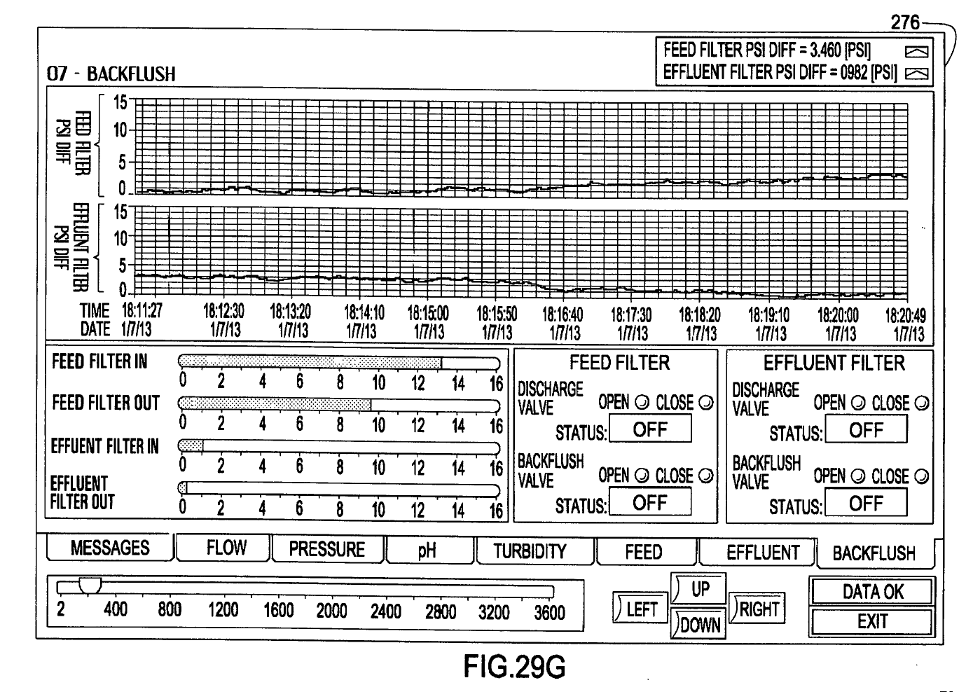

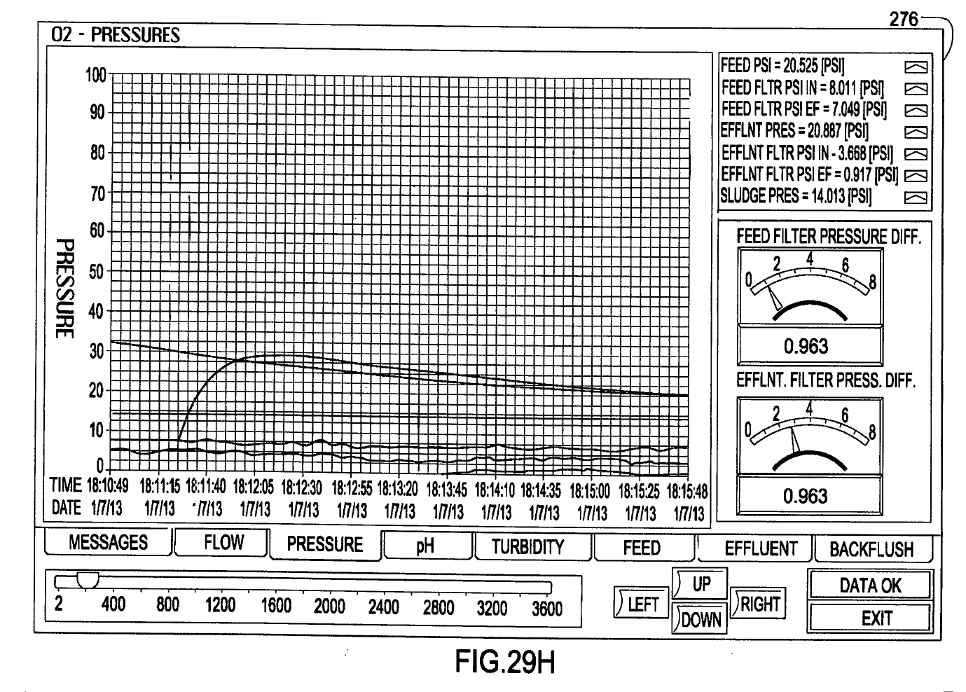

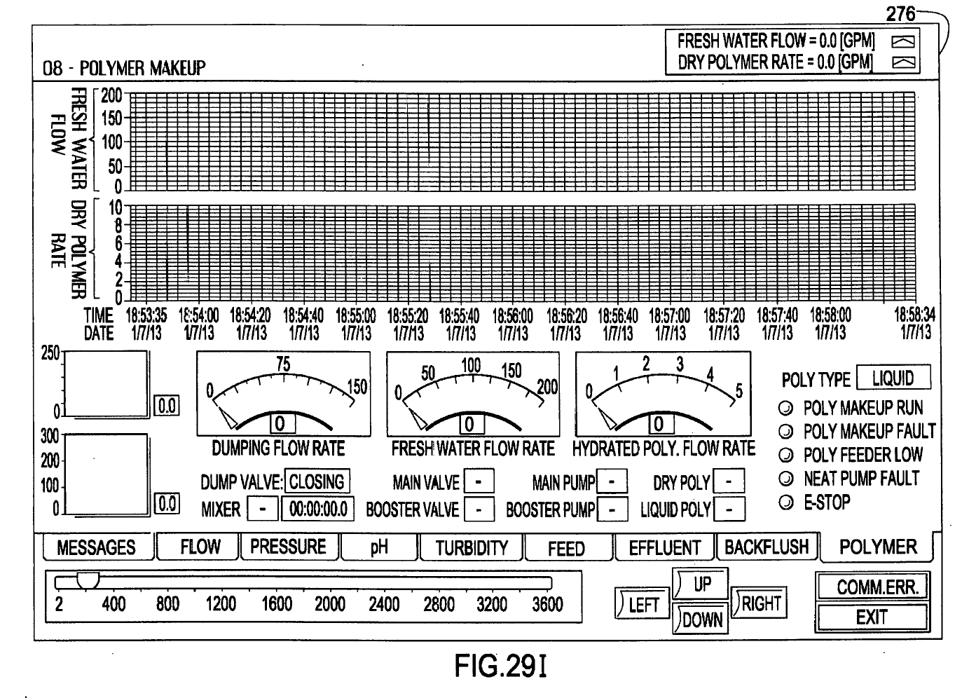

FIG. 26 illustrates wiring and data flow between units 37 and 39 of station 35. Programmable logic controllers 269 and 271 are located at units 37 and 39, respectively, at transfer terminal 55 and assembly 85, respectively. These controllers are in constant communication for transfer of feedback data and control signals between the units. Both units include sensing options 273 and 275 for monitoring fluid quality (as discussed hereinabove for unit 37), pump, valve and mixer performance, flowback tank pressure, and chemical storage use and status. All motorized valves at treatment unit 37 are directly controlled by controller 269 and by controller 271 via controller 269. Variable frequency drive pumps and mixers are controlled from drivers 273 at assembly 85 of unit 39 through terminal 55. Valve state feedback and mixer or pump overheating feedback to controller 271 is conducted via controller 269. Pumps and valves at management unit 39 are directly controlled by controller 271, which also directly monitors activity of all manual switches at unit 39. A panel pc 276 is located at unit 39 for operations monitoring from within unit 39 and for direct program control of controller 271 (see FIG. 29 showing various control and data monitoring displayed thereon).

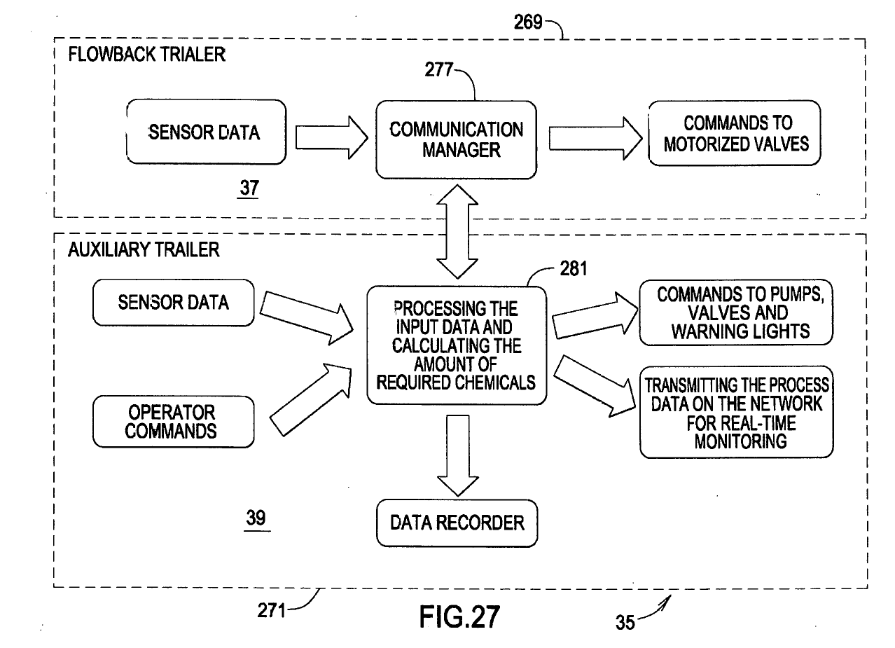

Process control using controllers 269 and 271 is illustrated in FIG. 27. Treatment unit 37 controller 269 software includes a communications manager 277 which reads sensor and performance data at unit 37. Manager 277 reports this data to controller 271 for use by the process control software program thereat, and receives operating control output from controller 271. Responsive to receipt of the control output, manager 277 controls output of signals to the various motorized valves. Process control 281 at controller 271 receives sensor and performance data signals from the various assemblies in management unit 39 together with operator commands as additional input and sends commands to the pumps, valves and alarms on-board management unit 39 as well as to communications manager 277. Data recording and transmitting on the network or in resident memory is controlled by controller 271 process control 281.

Process control 281 includes basic programming which coordinates rate of chemical injection as a function of feed rate measured by resident feed flow meter, and pH measurements, conductivity measurements, turbidity measurements and temperature measurements from treatment unit 37. Real time data acquisition accommodates process control program software development to automate the chemical injection rates and ratios.

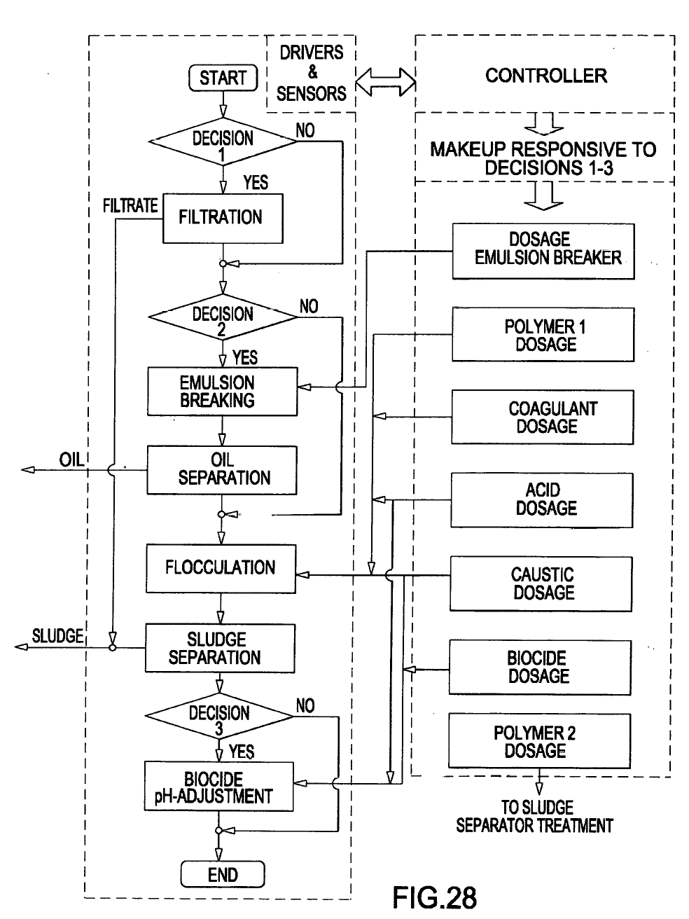

Referring to FIGS. 26, 27, 28 and 29, process control of mobile liquid treatment unit 37 includes sensing attributes of liquid to be treated and operational functioning of unit components, such as speed and state attributes (on/off, for example), providing electronic outputs indicative thereof to controller 271. The outputs are then utilized by process control 281 to generate process control signals responsive thereto which direct the various dosing equipment in preparation of chemical dosing at management unit 39. The control signals are also received at treatment unit 37 for selectively adapting the attributes of operational functioning. The chemical dosing is pumped to treatment unit 37 from treatment management unit 39 for injection in the liquid being treated thereat. Data indicative of the electronic outputs and control signals is acquired and reported and/or saved at controller 271.

In addition, control signals related to back flush operation at treatment unit 37 are generated by controller 271 responsive to the electronic outputs. These are utilized at the treatment unit to initiate back flush operations, and for operator reference in maintaining or upgrading back flush equipment process control and performance (for example, by monitoring flow back frequency and utilizing the frequency data for filter screen size optimization).

Automation of dosing preparation may be controlled from controller 271, controlling, for example, metering of chemicals responsive to the control signals, pumping and pumping parameters of the metered chemicals to treatment unit 37, and recording of metering and pumping operational functioning. For control of flowback feed into treatment unit 37, process control software at controller 271 reads the sensed volume flowback tank sensor output indicative of liquid at the flowback tank and provides flow rate control signals responsive thereto which are received at treatment unit 37 for adapting the attributes of liquid infeed and throughflow control functioning. Process control software at controller 271 is thus able to continuously receive and monitor the various electronic outputs and responsive thereto continually generate process control signals for correcting or improving liquid treatment at the site. Continual monitoring of operations and process control and recording and/or transmitting the same assures quality record keeping and enables real-time remote monitoring.

FIG. 29 illustrates process monitoring and control displays at panel pc 276 from which an operator may run station 35 from management unit 39. FIG. 29A shows the home screen for feed measurements readout and control operations. The home screen for the various flow rate measurements and controls is shown in FIG. 29B, with pH and Turbidity monitoring of the various compartments shown in FIGS. 29C and 29D. The effluent measurement displays and controls home screen is illustrated in FIG. 29E, with FIG. 29F showing an operator alerts and alert clearing screen directed to urgent control issues arising at the station. FIG. 29G, 29H and 29I are home screens for back flush, pressure and polymer makeup monitoring and controls, respectively. Each of the home screens has multiple pages for detailed monitoring (controlled from the upper right pane). A series of tabs at the bottom allow navigation through the various monitoring/control screens. Navigation on a particular screen is accommodated by the navigation controls at the bottom of each screen.

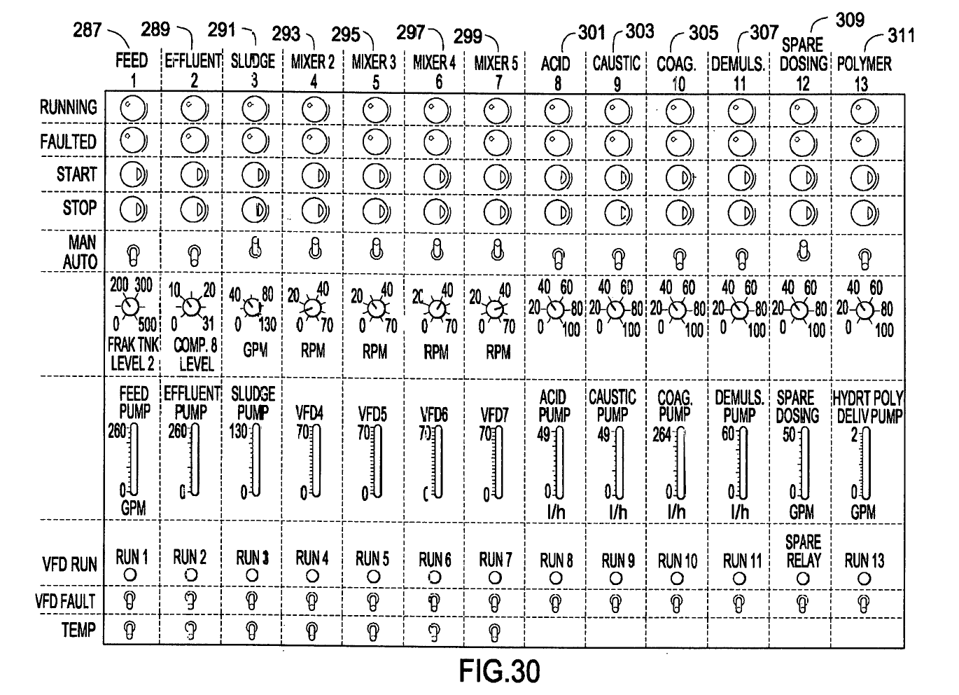

All process control can be simulated and utilized (for example on a laptop or other computer) for training, unit development, and off-site programming of process control functions. This simulation software is an exact duplication of the process control software programming onboard at management unit 39 and includes displays of the various treatment unit responses to operator activities or programming changes (see FIGS. 30 through 32).

The core process is a crucial part of the process software. It is used in both the main control program of controller 271 and also in the flowback simulator. The core process reads all sensors, reads state and value of all user controls, controls all pumps, mixers and motorized valves either in manual or automated mode, records all the process data locally, and makes available the process data through the network in real-time for remote monitoring.

The flow rate of feed pump 63 controls the overall speed of the process. It is important to maintain at least a minimum flow through the whole process in order to enhance the quality of the chemical treatment process. Process control programming of flow rate is based on the level of the fluid in the fracking tank as sensed and signaled by means of the sensor 282 in the fracking tank. The advantage of this method is that while the number of external sensors is kept to a minimum, the operator is still able to adjust the speed of the process based on different conditions. This method also allows processing of fracking liquids to begin even while new liquid is still being added to the fracking tank. For example, in a freezing environment the operator may anticipate that more fluids may come out of the well for the next 24 hours. The discharge of the fracking fluid from the well happens at sporadic times, and it is desirable to keep the process running without interruption to prevent freezing. Therefore, the operator can set the desired level of the fracking tank such that there is enough free space in the flowback tank to hold any new fluids from the well while maintaining enough fracking fluid reserve in the tank to keep the process running in between the periods of fracking fluid discharge.

Simulator operation is shown in FIGS. 30 through 32. FIG. 30 is columnar control and operations display. In the upper half FIG. 30 all the controls visible at the cover of the processing assembly 85 control cabinet at panel pc 276 are reproduced in simulation. The columns relate to (left to right) feed pump 63 at column 287, effluent pump 65 at column 289, sludge pump 195 at column 291, mixer 69 at compartment 153 at column 293, mixer 69 at compartment 167 at column 295, mixer 69 in compartment 159 at column 297, mixer 69 in compartment 161 in column 299, acid dosing pump(s) 97 at a dosing platforms 81 in column 301, caustic dosing pump(s) 97 at a dosing platforms 81 in column 303, coagulant dosing pump(s) 97 at a dosing platforms 81 in column 305, demulsifier dosing pump(s) 97 at a dosing platforms 81 in room 93 in column 307, spare dosing pump(s) 97 (if present) at a dosing platforms 81 in column 309, and dosing pump(s) 97 for polymer storage and flocculant makeup system 91 at column 311. As can be seen there are status lights, start/stop buttons and speed control potentiometers for each variable frequency drive (VFD) motor in the system. In the lower half of FIG. 30, the indicators for the speed of each VFD motor in the form of bar meters are presented. The lights below show if a VFD motor is currently energized. There are switches for each VFD motor that simulate an overheating signal or any other kind of fault.

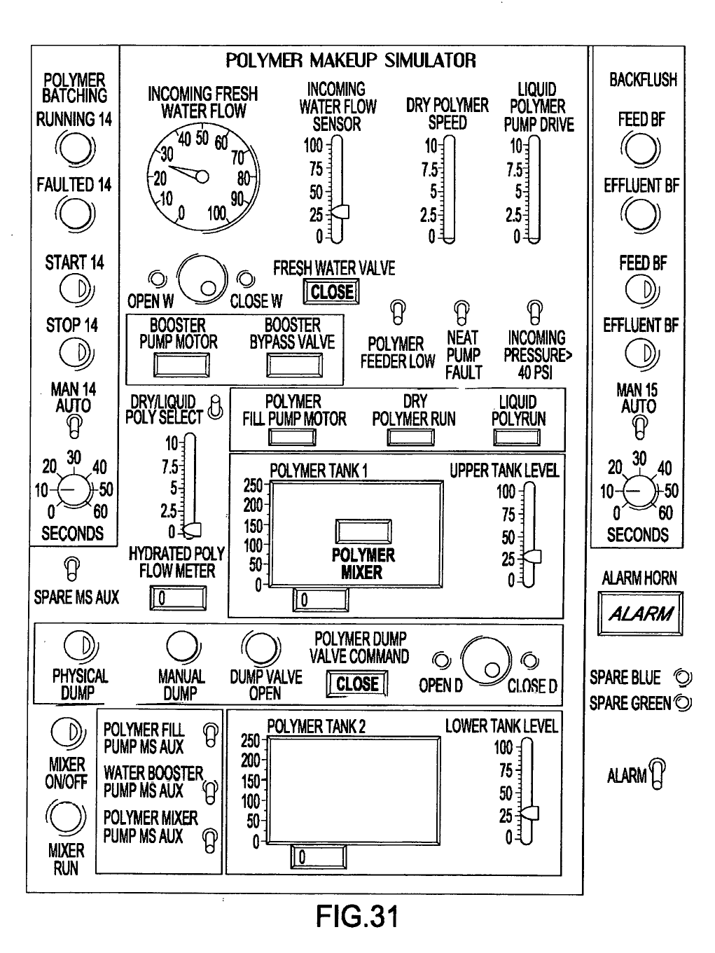

In FIG. 31, the polymer makeup and delivery functions are shown in simulation. The polymer makeup system can be run independently from the rest of the simulation. The water and polymer pumps start at the correct sequence to mix the concentrated polymer in the upper tank and to store it in the lower tank. Back flushing simulation at the right side of FIG. 31 replicates operator controls at assembly 85 for back flushing. Operation progress lights, and manual start buttons are provided as is an automatic back flush controller.

At the center of FIG. 32, simulation of operation of motorized valves that govern the flow of the fluids during the back flush process is shown. At the top of the FIGURE all the different sensors in treatment unit 37 are simulated with state and values displayed. These include (from left to right) feed level sensor 282 at column 313, feed pump pressure switch sensor at column 315, influent filter pressure sensor at column 317, effluent filter pressure sensor at column 319, feed flow rate sensor at column 321, feed temperature sensor at column 323, feed condition sensor at column 325, feed pH sensor at column 327, pH at compartment 157 sensor at column 329, compartment 157 turbidity sensor at column 331, compartment 159 pH sensor at column 333, compartment 167 level sensor at column 335, effluent pump pressure switch sensor at column 337, influent pressure sensor at column 339, effluent pressure sensor at column 341, effluent flow rate sensor at column 343, effluent pH sensor at column 345, effluent turbidity sensor at column 347, and sludge pump pressure switch sensor at column 349.

Reading of these sensors is used by the core process of process control software programming to either control the station or to store their values on non-volatile memory. The cascading compartments 47 of flowback unit 37 are simulated at the bottom right of the FIGURE. When feed pump 63 is running, the level of the fluid in compartment 153 will increase proportional to the flow rate. After the fluid level reaches a certain level, it will over flow to the next compartment and this display will continue for all the compartments. The reverse cycle is displayed at unit 37 is emptied. The status of the fracking fluid flowback tank (and thus incoming liquid flow availability) is simulated at the left of the FIGURE. In simulation it is possible to select the amount of the incoming flow to the flowback tank, while in real time operations the incoming flow rate is determined by the amount of fracking fluids that are being discharged from the well.

As may be appreciated from the foregoing, a highly responsive easily manipulable liquid treatment station is provided by this invention wherein liquid treatment functions are separated from treatment management functions. Use of the station will provide water purification to such an extent that most of the effluent is safe for industrial reuse on the site or at another site, and in many cases to such an extent that direct recycling may be possible (in a stream flow or well in the case of oil/gas well drilling flowback water, for example).

What is claimed is:

1. A mobile station for liquid treatment at a site comprising:
a primary liquid treatment unit maintained on a first trailer and having a foul liquid intake end and a purified liquid output end with a plurality of liquid treatment compartments and a plurality of intermediate structure defined and serially arranged therebetween, different ones of said compartments accommodating different liquid treatment including chemically enhanced oil/water separation, coagulation, pH-buffering, flocculation, and solids separation, said primary treatment unit having a plurality of chemical dosing inputs at a lower portion of different ones of said compartments and a plurality of mixer impellers at a lower portion of different ones of said compartments, said intermediate structure residing between said compartments and configured to provide primary liquid inflow to an adjacent downstream one of said compartments at said lower portion thereof and below any said chemical dosing input or said mixer impeller thereat, and said intermediate structure receiving primary liquid outflow from an adjacent upstream one of said compartments through a water level adjustable weir structure at an upper portion of said upstream one of said compartments, said weir structure adjustable to define maximum compartment treatment volume, said compartment volumes, said primary liquid inflow and outflow locations, relative said weir structure heights and said mixer impellers when provided promoting fluid lifting in said compartments during treatment and mixing and pumpless flow of fluid through said primary liquid treatment unit;
a mobile treatment management unit maintained on a second trailer having a plurality of chemical dosing platforms and a central power and processing assembly therein, said chemical dosing platforms including chemical storage connectable with dosing pump assemblies operatively associated with said power and processing assembly and having dosing outputs; and
means connectable between said units for power, data and chemical feed therebetween.

2. The treatment station of claim 1 wherein said means for power data and chemical feed between said units includes an externally located dosing manifold at said management unit connected with said dosing outputs, an externally located power and data input and output terminal associated with said central power and processing assembly of said management unit, a power and data transfer terminal at said treatment unit, a bus connectable at the site between said power and data input and output terminal and said power and data transfer terminal, and chemical feed line assemblies selectively connectable at the site between said dosing manifold of said management unit and said dosing inputs at said compartments of said primary treatment unit.

3. The treatment station of claim 2 further comprising a plurality of sensors at said treatment unit with sensor outputs, a plurality of pumps, mixer motors associated with said mixer impellers and valves having connections for operational control and feedback, said power and data transfer terminal connected with said connections of said pumps, mixer motors and valves and said sensor outputs from said sensors.

5. The treatment station of claim 3 wherein said sensors include a pressure sensor connected between said power and processing assembly at said management unit and an on-site source of foul fluid received at a feed pump located at said intake end of said primary treatment unit for infeed and throughflow control and monitoring based on available volume of foul fluid at the source.

6. The treatment station of claim 3 wherein said sensors of said primary treatment unit include at least one of liquid intake and liquid output location of turbidity and pH measurement devices providing feedback to said management unit for refining control of chemical dosing and for ongoing data collection.

7. The treatment station of claim 1 wherein said compartments include an emulsion breaking compartment, an oil separation compartment, chemical dosing and polymer treatment compartments, a solids separation compartment, a final dosing compartment, and a buffer compartment adjacent said output end for flow control.

8. The treatment station of claim 1 wherein said primary treatment unit includes internal leveling features for independent leveling of components located in at least some of said compartments.

9. The treatment station of claim 1 wherein said management unit further includes a polymer storage and flocculant makeup system having an output.

10. The treatment station of claim 9 wherein said management unit further includes demulsifier storage and dosing system having an output.

11. The treatment station of claim 10 further comprising an externally located dosing manifold at said management unit connected with said dosing outputs, said polymer storage and flocculant makeup system output and said demulsifier storage and dosing system output.

12. A method for operation of a mobile liquid treatment station locatable at a treatment site comprising the steps of:
locating separate trailer mounted liquid treatment and treatment management units adjacent to each other at the treatment site;
intake at the liquid treatment unit of foul liquid for treatment;
serially treating fluid in the liquid treatment unit in separate compartments thereof each separated by intermediate flow structure, treatment functions including chemically enhanced oil/water separation, coagulation, pH-buffering, flocculation, and solids separation;
applying chemical dosing at a lower portion of different ones of the compartments;
assisting lifting mixing by mixing impellers located at a lower portion of different ones of the compartments;
providing primary liquid inflow from the intermediate flow structure between compartments to an adjacent downstream one of the compartments at the lower portion thereof and below any of the chemical dosing application or the lifting mixing impeller thereat;
receiving primary liquid outflow to the intermediate flow structure between compartments from an adjacent upstream one of the compartments through outflow structure at an upper portion of the upstream one of the compartments;
adjusting water level at the outflow structure to define maximum compartment treatment volume, whereby compartment volumes, primary liquid inflow and outflow locations, relative outflow structure heights and lifting mixing impellers promote fluid lifting in the compartments during treatment and mixing and pumpless flow of fluid through the liquid treatment unit;
centrally powering both units, processing data and managing fluid flow from the treatment management unit;
controlling chemical dosing and makeup from chemical storage and dosing assemblies at the treatment management unit;
accommodating power, data flow and chemical feed between the units at the site; and
output of purified fluid after treatment from the treatment unit.

13. The method of claim 12 further comprising the steps of:
performing the liquid treatment functions at the compartments responsive to process control programming from a system at the treatment management unit;
sensing attributes of the liquid at the treatment unit and attributes of operational functioning of selected treatment unit components and providing electronic outputs indicative thereof to the system; and
preparing chemical dosing at the treatment management unit responsive to the received outputs.

14. The method of claim 13 further comprising the steps of providing operator control inputs at the treatment management unit for operator control of selected operations at the treatment unit and adapting control parameters from the system responsive to the sensed operator manipulation of the control inputs.

15. The method of claim 13 wherein the selected treatment unit components include pumps, mixers and valves and wherein the attributes of operational functioning include speed and state attributes.

16. The method of claim 13 further comprising the step of monitoring the chemical dosing at the system, generating process control signals from the system indicative of the monitoring, wherein the selected treatment unit components include a sludge pump and wherein the attributes of operational functioning include pump speed.

17. A mobile station for liquid treatment at a site comprising:
a primary liquid treatment unit maintained on a first trailer and having a foul liquid intake end and a purified liquid output end with a plurality of liquid treatment compartments and a plurality of intermediate structure defined and serially arranged therebetween, different ones of said compartments accommodating different liquid treatment including chemically enhanced oil/water separation, coagulation, pH-buffering, flocculation, and solids separation, said primary treatment unit having a plurality of chemical dosing inputs at a lower portion of different ones of said compartments and a plurality of mixer impellers at a lower portion of different ones of said compartments, said intermediate structure residing between said compartments and configured to provide primary liquid inflow to an adjacent downstream one of said compartments at said lower portion thereof and below any said chemical dosing input or said mixer impeller thereat, and said intermediate structure receiving primary liquid outflow from an adjacent upstream one of said compartments through a water level adjustable weir structure at an upper portion of said upstream one of said compartments, said weir structure adjustable to define maximum compartment treatment volume, said compartment volumes, said primary liquid inflow and outflow locations, relative said weir structure heights and said mixer impellers when provided promoting fluid lifting in said compartments during treatment and mixing and pumpless flow of fluid through said primary liquid treatment unit;
a mobile treatment management unit maintained on a second trailer and including a treatment controller center located at said platform having a control output and feedback input associated therewith adapted at plural connection nodes, a chemical dosing control center located at said platform and operatively associated with said controller center and including chemical dosing outputs associated therewith to transfer dosing fluids from said management unit, and at least a first auxiliary functions center located at said platform, none of said centers having an inlet or outlet for direct receipt and distribution of the liquid to be treated on the site; and
means connectable between said units for power, data and chemical feed therebetween.

18. The mobile station of claim 17 wherein said treatment controller center of said management unit is operative responsive to a process control program both resident at said management unit and remotely manipulable.

19. The mobile station of claim 18 wherein said management unit process control program includes means for process adaptation responsive to feedback input from said units.

20. The mobile station of claim 17 further comprising means for generating process control signals at said treatment controller center of said management unit responsive to feedback outputs received and selectively adapting attributes of operational functioning of selected components at the units responsive to the control signals, wherein said selected components located at said treatment unit include pumps, mixer motors and valves, and wherein said attributes of operational functioning include speed and state attributes.
